(19) United States
(12) Patent Application Publication
(10) Pub. No.: US 2025/0012515 A1
(43) Pub. Date: Jan. 9, 2025

(54) THERMAL ENERGY STORAGE

(71) Applicant: Erich Gademan Stephens, Providence, RI (US)

(72) Inventor: Erich Gademan Stephens, Providence, RI (US)

(21) Appl. No.: 18/699,953

(22) PCT Filed: Oct. 14, 2022
(86) PCT No.: PCT/US22/78084

§ 371 Date: Apr. 10, 2024

Related U.S. Application Data
(60) Provisional application No. 63/255,992, filed on Oct. 15, 2021.
(60) Provisional application No. 63/289,202, filed on Dec. 14, 2021.

(51) Int. Cl. F28D 20/00

(52) U.S. Cl. CPC F28D 20/0056; F28D 2020/0026; F28D 2020/0069

(57) ABSTRACT

A method of storing thermal energy includes providing a thermal storage material (TSM) comprising magnesium; delivering thermal energy into the TSM; and subsequently removing the thermal energy from the TSM for a practical purpose. The thermal energy may be delivered into the TSM at a first location and the thermal energy may be removed from the TSM at a second location that is different than the first location.

### CROSS-REFERENCE TO RELATED APPLICATION(S)

This application claims the benefit of priority to U.S. Provisional Patent Application No. 63/255,992, entitled Cableless Energy Transmission, which was filed on Oct. 15, 2021, and U.S. Provisional Patent Application No. 63/289,202, entitled Cableless Energy Transmission, and filed on Dec. 14, 2021. The disclosures of the prior applications are incorporated by reference herein in their entireties.

### FIELD OF THE INVENTION

This disclosure relates to thermal energy storage and, more specifically, relates to systems and techniques for storing thermal energy, including for stationary storage applications and storage applications associated with or involving transporting the stored energy.

### BACKGROUND

Energy storage refers to the capture of energy at one time for use at a later time. Typically, energy storage technologies can help reduce temporal and/or geographic imbalances between energy demand and energy production. There are a variety of different types of energy storage include, for example, mechanical, electrical, thermal, and others. Thermal energy storage refers to energy storage in which the energy is stored in the form of heat.

### SUMMARY OF THE INVENTION

In various aspects, this disclosure relates to thermal energy storage and, more specifically, relates to systems and techniques for storing thermal energy, including for stationary storage applications and storage applications associated with or involving transporting the stored energy.

In one aspect, a method of storing thermal energy includes providing a thermal storage material (TSM) comprising magnesium; delivering thermal energy into the TSM; and subsequently removing the thermal energy from the TSM for a practical purpose. The thermal energy may be delivered into the TSM at a first location and the thermal energy may be removed from the TSM at a second location that is different than the first location. In such implementations, the method also includes physically transporting the TSM from the first location to the second location while the TSM is storing the thermal energy. In some implementations, the method includes providing the thermal energy for delivery into the TSM, which may include using a system selected from the group consisting of a system that includes an electric generator, a geothermal system, and a solar or solar-powered system, or any other type of system that may generate or produce or provide electricity or heat (e.g., heated fluid, radiated heat, which is then captured in a fluid, etc.).

Typically, a geothermal system uses the heat of the earth, which may include heat from volcanic formations, and a solar-powered system utilizes thermal energy from the sun, or a system may provide heat from the combustion of a fuel, where the fuel may be a biomass fuel (such as wood material or crop residue), chemical fuel (whether synthesized or fossil fuel extracted from the earth), heat from radioactive decay or nuclear fission or fusion, or waste heat created by an industrial process, etc.

In another aspect, a method of storing thermal energy includes providing a thermal storage material (TSM) (that may contain magnesium); delivering thermal energy into the TSM; and subsequently removing the thermal energy from the TSM for a practical purpose. Delivering the thermal energy into the TSM in these implementations may include using a fluid intermediary to transfer heat from a source of thermal energy into the TSM. Additionally, or alternatively, the subsequent removal of thermal energy from the TSM may include the use of the fluid intermediary to remove heat from the TSM. The fluid intermediary typically includes magnesium. The thermal energy may be delivered into the TSM at a first location and the thermal energy may be removed from the TSM at a second location that is different than the first location. In those instance, the method typically includes physically transporting the TSM from the first location to the second location while the TSM is storing the thermal energy.

In yet another aspect, a method includes providing a container that contains an accumulation of solid thermal storage material (TSM), that may include magnesium, with interstices formed throughout the accumulation, and that has a plurality of fluid communication ports that may singly or in groups positioned at different heights above a bottom surface of the container. The method includes introducing a heated fluid into the container via a first one or group of the plurality of fluid communication ports at a first height above the bottom surface of the container. The heated fluid thus introduced into the container flows from the first height down through the interstices in the TSM under the influence of gravity while heating the TSM that the heated fluid flows past. Subsequently, the introduction of the heated fluid into the container via the first one or group of the plurality of fluid communication ports positioned at the first height is discontinued and instead the heated fluid is introduced into the container via a second one or group of the plurality of fluid communication ports at a second height above the bottom surface of the container, where the second height is lower than the first height. The heated fluid introduced into the container via the second fluid communication port or group of ports flows through the interstices in the TSM under the influence of gravity while heating the TSM that the heated fluid flows past.

Temperature monitors monitor one or more temperatures (e.g., a different heights) inside the container. Discontinuing the introduction of the heated fluid into the container via the first one of the plurality of fluid communication ports and instead introducing the heated fluid into the container via a second one of the plurality of fluid communication ports occurs automatically in response to a signal (e.g., from one or more of the temperature monitors) indicating that a particular one of the monitored temperatures has reached a predetermined value. In some implementations, the method includes heating the fluid to produce the heated fluid, which generally involves transferring thermal energy from a source of thermal energy into the fluid. The source of thermal energy can be any source of thermal energy including a system selected from the group consisting of a system that includes an electric generator, a geothermal system, and a solar-powered system.

In another aspect, a method includes providing a container that contains an accumulation of solid heated thermal storage material (TSM), (e.g., containing magnesium), with interstices formed throughout the accumulation, and that has a plurality of fluid communication ports at different heights relative to a bottom surface of the container; introducing a fluid into the container via a first one of the plurality of fluid communication ports at a first height either through or above the bottom surface of the container, where the unheated fluid introduced into the container flows from the first height up through the interstices by means of pumping or pressurizing the fluid, and while being heated by the heated TSM that the fluid flows past, and removing the fluid from the container via a second one of the plurality of fluid communication ports that is located at a second height that is above the first one of the plurality of fluid communication ports; and subsequently discontinuing the removal of the fluid from the container via the second one of the fluid communication ports and instead removing the fluid from the container via a third one of the plurality of fluid communication ports at a third height above the bottom surface of the container, wherein the third height is higher than the second height, and wherein the fluid removed from the container via the third fluid communication port has flowed through the interstices by means of pumping or pressurizing the fluid while being heated by the heated TSM that the fluid flows past.

In some implementations, the method includes monitoring one or more temperatures inside the container. In those implementations, discontinuing the removal of the heated fluid from the container via the second one of the plurality of fluid communication ports and instead removing the heated fluid from the container via a third one of the plurality of fluid communication ports occurs automatically in response to a signal indicating that a particular one of the monitored temperatures has reached a predetermined value. The method may further include utilizing the heated fluid for a practical application.

In still another aspect, a method includes providing a thermal energy source at a first location; providing a plurality of movable vessels, each of which comprises one or more containers for thermal storage material (TSM); establishing a first load of heated TSM in a first container on a first one of the plurality of movable vessels using thermal energy from the thermal energy source; physically transporting the first load of heated TSM from the first location to a second location with the first one of the plurality of movable vessels, wherein the second location is different than the first location; removing the thermal energy from the first load of heated TSM at the second location for a practical purpose; establishing a second load of heated TSM in a second container on a second one of the plurality of movable vessels using thermal energy from the thermal energy source, while the first load of heated TSM is being physically transported or utilized at the second location; physically transporting the second load of heated TSM from the first location to the location or to a third location with the second one of the plurality of movable vessels, wherein the third location is different than the first location and the second location; and removing the thermal energy from the second load of heated TSM at the second or third location for a practical purpose.

In some implementations, establishing the first load of heated TSM in the first container on the first one of the plurality of movable vessels using thermal energy from the thermal energy source includes: initially providing the first container in an empty condition on the first one of the plurality of movable vessels; initially providing a first load of unheated liquid TSM in a second container also on the first one of the plurality of movable vessels; and pumping the unheated liquid TSM from the second container through a heat exchanger to absorb heat from the thermal energy source and into the first container. Some implementations include establishing a first fluid communication path: from the first container on the first one of the plurality of movable vessels to the heat exchanger; and from the heat exchanger to the second container on the first one of the plurality of movable vessels. The first fluid communication path facilitates flow of the unheated liquid TSM from the second container, through the heat exchanger, and into the first container. Some implementations include establishing, but temporarily preventing fluid flow through, a second fluid communication path: from a first container on the second one of the plurality of movable vessels to the heat exchanger; and from the heat exchanger to the second container on the second one of the plurality of movable vessels. The second fluid communication path is configured, when the temporary fluid flow prevention is removed, to facilitate flow of the unheated liquid TSM from the first container on the second one of the plurality of movable vessels, through the heat exchanger, and into the second container on the second one of the plurality of movable vessels. The second fluid communication path may be established, but with the temporary fluid flow prevention, while the first fluid communication path is in place.

In some implementations, establishing the first load of heated TSM in the first container on the first one of the plurality of movable vessels using thermal energy from the thermal energy source comprises: providing a first load of unheated solid TSM in the first container of the first one of the plurality of movable vessels; transferring the thermal energy from the thermal energy source into an intermediary fluid to produce a heated intermediary fluid; pumping the heated intermediary fluid to the unheated solid TSM; and transferring thermal energy from the heated intermediary fluid into the unheated solid TSM by allowing the heated intermediary fluid to flow over the unheated solid TSM to produce the first load of heated TSM.

The method may include the use of a liquid TSM and providing three connection points for liquid TSM connections for a heat exchanger for the thermal energy source. In some such implementations, establishing the second load of heated TSM (e.g., containing magnesium) in the second container on the second one of the plurality of movable vessels using thermal energy from the thermal energy source includes: establishing a first fluid communication path between the first container on the first one of the plurality of movable vessels and the heat exchanger via a first one of the three connection points; establishing a second fluid communication path between the heat exchanger and the second container on the second one of the plurality of movable vessels via a second one of the three connection points; and establishing, but temporarily preventing flow through, a third fluid flow path between the heat exchanger and a third container on a third one of the plurality of movable vessels via a third one of the three connection points.

In some such implementations, establishing the second load of heated TSM in the second container on the second one of the plurality of movable vessels using thermal energy from the thermal energy source further includes pumping a liquid TSM: from the first container on the first one of the plurality of movable vessels to the heat exchanger via the first fluid communication path, through the heat exchanger to heat the liquid TSM and thereby produce the second load of heated TSM, and from the heat exchanger to the second container on the second one of the plurality of movable vessels via the second fluid communication path.

In some such implementations, the method includes stopping fluid flow through the second fluid communication path; and detaching a fluid line that extends from the second container on the second one of the plurality of movable vessels from the second one of the three connection points so that the second one of the plurality of vessels is free to physically transport the second load of heated TSM from the first location to the second location or to the third location.

In some such implementations, the method further includes terminating the temporary prevention of fluid flow through the third fluid flow path between the heat exchanger and the third container on the third one of the plurality of movable vessels, and pumping the unheated liquid TSM: from the third container on the third one of the plurality of movable vessels to the heat exchanger via the third fluid communication path, through the heat exchanger to heat the liquid TSM and thereby produce the first load of heated TSM, and from the heat exchanger to the first container on the first one of the plurality of movable vessels via the first fluid communication path.

In some such implementations, the method further includes establishing a fourth fluid flow path between the heat exchanger and a fourth container on a fourth one of the plurality of movable vessels via the second one of the three connection points.

In still another aspect, a method includes providing an airtight container; filling the airtight container with a thermal storage material (TSM); and creating a full or partial vacuum inside at least part of the airtight container. The full or partial vacuum inside the airtight container slows or limits a loss of thermal energy from the heated TSM inside the airtight container. In some implementations, the full or partial vacuum is created in a space around and in direct physical contact with the TSM. The full or partial vacuum may be created before, during, or after the TSM has been heated. In some implementations, the airtight container includes: an internal container and an external container. The internal container is inside the external container with a space between at least part of the internal container and at least part of the external container. Creating the full or partial vacuum may happen inside at least part of the airtight container by creating the full or partial vacuum inside only the space between the internal container and the external container. Typically, the thermal energy is removed from the TSM for a practical purpose at a time and/or place where the thermal energy will have a desired use (e.g., which may be more desirable or valuable than when and/or where it was stored).

The TSM (e.g., containing magnesium) may be stored inside the container as a solid. In some such implementations, the container has one or more racks inside an outer wall of the container. The one or more racks can be positioned and configured to support the solid TSM in such a manner that the solid TSM is held away from an inner surface of the outer wall of the container. Moreover, creating the full or partial vacuum comprises evacuating air from a space around the solid TSM.

In another aspect, a method includes providing an electrical generator to produce electricity at a first location; providing two or more connection points for accessing the electricity produced by the electrical generator; providing a plurality of movable vessels, each of which comprises a container containing thermal storage material (TSM) (e.g., containing magnesium); transferring the electricity to a first one of the plurality of movable vessels via a first one of the two or more connection points; transforming the electricity into thermal energy onboard the first one of the plurality of movable vessels and storing the thermal energy in the TSM on the first one of the plurality of movable vessels to create a first load of heated TSM; physically transporting the first load of heated TSM from the first location to a second location with the first one of the plurality of movable vessels, wherein the second location is different than the first location; and removing the thermal energy from the first load of heated TSM at the second location for a practical purpose.

In some implementations, the method includes transferring the electricity to a second one of the plurality of movable vessels via a second one of the two or more connection points; transforming the electricity into thermal energy onboard the second one of the plurality of movable vessels and storing the thermal energy in the TSM on the second one of the plurality of movable vessels to create a second load of heated TSM; physically transporting the first load of heated TSM from the first location to a second location with the first one of the plurality of movable vessels, wherein the second location is different than the first location; and removing the thermal energy from the first load of heated TSM at the second location for a practical purpose. In some such implementations, transferring the electricity to the second one of the plurality of movable vessels overlaps transferring the electricity to the first one of the plurality of movable vessels so as to provide for continuous (without interruption) storage of the electrical energy. Moreover, in some such implementations, transferring the electricity to the second one of the plurality of movable vessels does not overlap transferring the electricity to the first one of the plurality of movable vessels, however the physical connections to transfer electricity are in place simultaneously so that when the transfer of electricity stops to a vessel it can immediately begin going to another vessel. The electricity may be transformed into thermal energy in a heat exchanger that uses the electricity to heat an intermediary fluid that is then delivered to the TSM. The electricity may be transformed into thermal energy by passing the electricity through one or more electrical resistance heaters that are physically or thermally coupled to the TSM either directly or through a fluid intermediary.

In another aspect, a method includes generating electricity with an electrical generator, transferring energy from the generated electricity into a thermal storage material (TSM) to produce heated TSM (where the energy is transferred from the generated electricity into the thermal storage material using a first fluid intermediary), transporting the heated TSM with a transport vehicle to a remote location, and converting the energy from the heated TSM into electricity at the remote location.

In some implementations, the electricity is generated by an offshore wind turbine generator, the transport vehicle is a floating vessel (e.g., a ship, a boat, a barge, etc.), and transporting the heated TSM with the transport vehicle to the remote location comprises sailing the floating vessel from the offshore wind-powered electrical generator to a shoreside energy conversion station. The TSM may be in a solid (e.g., granular, powdered, etc.) form and the first fluid intermediary may be circulated through a bed of the solid TSM. The first fluid intermediary can be a liquid composed of a suspension or solution of Magnesium Oxide or Magnesia Carbon and, in any event, contains Magnesium.

In some implementations, transferring the energy from the generated electricity into the thermal storage material (TSM) to produce the heated TSM includes heating the first fluid intermediary with the electricity to produce a heated first fluid intermediary, and delivering the heated first fluid intermediary into a container that contains the TSM so that the heated first fluid intermediary flows over the TSM releasing heat to the TSM thereby resulting in the heated TSM. In some implementations, delivering the heated first fluid intermediary into the container that contains the TSM includes introducing the heated first fluid intermediary into the container that contains the TSM at a first height above a base of the container that contains the TSM; and in response to a temperature inside the container (e.g., at a particular one of several temperature monitoring points or heights within the container) reaching a target value, suspending introducing the heated first fluid intermediary at the first height and instead introducing the heated first fluid intermediary into the container that contains the TSM at a second height above the base of the container. The second height above the base is lower than the first height above the base.

The thermal storage material typically is provided inside a container. In some implementations, air is evacuated from at least part of the space inside the container between the thermal storage material and a surface of the container. The thermal storage material may be stored inside the container as a liquid. In some of those implementations, the container may be a double-walled container that includes an inner wall that defines an internal storage compartment containing the thermal storage material and an outer wall outside and physically displaced from the inner wall to define a space between the inner wall and the outer wall. In some of those implementations, the thermal storage material may be in the storage compartment and evacuating the air from the space inside the container comprises evacuating air from the space between the inner wall and the outer wall. In some implementations, the thermal storage material is stored inside the container as a solid, and the container has a rack inside the container. The rack is positioned and configured to support the solid thermal storage material in such a manner that the solid thermal storage material is held away from an inner surface of the container that stores the TSM. The method, in those implementations, includes evacuating air from the inside the container comprising evacuating air from a space around the solid TSM.

In some implementations, the TSM includes, but is, or includes, but is not necessarily limited to, magnesium. In various implementations, the TSM is or includes Magnesium Oxide, or Magnesia Carbon.

In another aspect, a method includes generating electricity with an electrical generator; providing a plurality of movable vessels, each of which is carrying a load (i.e., a collection) of TSM; transferring energy from the generated electricity to the TSM on a first of the movable vessels using a first energy transfer connection; in response to a signal (e.g., a temperature signal from a temperature sensor thermally coupled to the TSM, e.g., on the container, on the TSM itself, or immediately adjacent to the TSM) indicating that the TSM on the first of the movable vessels has been fully charged, transferring the energy from the generated electricity to the TSM on a second of the movable vessels using a second energy transfer connection, and suspending the transferring of the energy using the first energy transfer connection; transporting the TSM on the first of the movable vehicles to a remote location; in response to a signal indicating that the TSM on the second of the movable vessels has been fully charged, transferring the energy from the generated electricity to the TSM on a third of the movable vessels using the first energy transfer connection, and suspending the transferring of the energy using the second energy transfer connection; transporting the TSM on the second of the movable vehicles to the remote location; and converting the energy from the TSM on the first and second movable vehicles into electricity at the remote location.

As mentioned above, the signal indicating that the TSM on the first of the movable vessels has been fully charged may be provided by a temperature sensor thermally coupled to the TSM on the first movable vessel, and the signal indicating that the TSM on the second of the movable vessels has been fully charged may be provided by a temperature sensor thermally coupled to the TSM on the second movable vessel. In some instances, the TSM on the second movable vessel is already coupled via the second energy transfer connection when the system switches from transferring the energy using the first energy transfer connection to transferring the energy using the second energy transfer connection.

In yet another aspect, a method includes: generating electricity with an electrical generator; providing a movable vessel carrying a first container containing a liquid thermal storage material (TSM), and a second container having sufficient available storage capacity to receive the liquid TSM from the first container; pumping the liquid TSM from the first container through a heater to absorb energy from the electricity generated by the electrical generator thereby producing a heated liquid TSM; returning the heated liquid TSM to the second container onboard the movable vessel; transporting the heated liquid TSM in the second container onboard the movable vessel to a remote location; and converting the energy from the heated liquid TSM in the second container onboard the movable vessel into electricity at the remote location.

In some implementations, the electricity is generated by an offshore wind turbine generator and transporting the heated TSM with the transport vehicle to the remote location comprises sailing (i.e., moving on the sea) the movable vessel from the offshore wind-powered electrical generator to a shoreside energy conversion station.

In still another aspect, a system includes at least one electrical generator; a remote energy conversion system; a movable vessel traveling back and forth between the at least one electrical generator and the remote energy conversion station; and a thermal storage material (TSM) on the vessel to carry energy from the at least one electrical generator to the remote energy conversion station. The energy is transferred from the generated electricity into the thermal storage material using a fluid intermediary.

In some implementations, the at least one electrical generator is at least one offshore wind-powered turbine generator, the remote energy conversion station is a shoreside energy conversion station, and the movable vessel is a floating vessel (e.g., a ship, a boat, a barge, etc.). In some such implementations, no electrically conductive cables extend between and are used to carry electricity between the offshore wind-powered turbine generator and the shoreside energy conversion station (or, if present, the cables are used less than they otherwise would be because of the energy transfer via TSM onboard the vessel(s)). The TSM may be in a solid form and the fluid intermediary may be circulated through a bed of the solid TSM.

The system, in some implementations, includes an electrical heater to heat the fluid intermediary and thereby produce a heated fluid intermediary; a container that contains the TSM; and a fluid communication channel to carry the fluid intermediary from the electrical heater to the container that contains the TSM. The heated fluid intermediary may be introduced into the container that contains the TSM so that the heated fluid intermediary flows over the TSM releasing heat to the TSM thereby producing heated TSM.

In some implementations, there are a plurality of inlets for the heated fluid intermediary to enter the container that contains the TSM, wherein each inlet is at a different height above a base of the container; a valve to control fluid flow through each of the plurality of inlets; one or more temperature sensors, each configured to sense a temperature within the container that contains the TSM; and a controller. The controller may be configured to send signals to open a first one of the valves to allow the heated fluid intermediary to flow into the container at a first height above a base of the container that contains the TSM; and in response to receiving a temperature signal from one of the temperature sensor(s) indicating that a temperature inside the container has reached a target value, close the first one of the valves and opening a second one of the valves to allow the heated fluid intermediary to flow into the container at a second height above the base of the container, wherein the second height above the base is lower than the first height above the base.

In some implementations, the system includes a container containing the thermal storage material therein, and a vacuum source (e.g., a vacuum pump, air ejector, etc.) fluidly coupled to the container and operable to evacuate air from a space inside the container between the thermal storage material and an exterior wall of the container. In some implementations, the TSM is stored inside the container as a liquid, and the container is a double-walled container that has an inner wall that defines an internal storage compartment containing the liquid thermal storage material, and an outer wall outside and physically displaced from the inner wall to define a space between the inner wall and the outer wall. In some implementations, the liquid thermal storage material is in the storage compartment and a vacuum source is fluidly coupled to the space between the inner wall and the outer wall.

The TSM may be stored inside the container as a solid. There may be a rack inside the container. The rack may be positioned and configured to support the solid thermal storage material in such a manner that the solid thermal storage material is held away from an inner surface of the container that stores the TSM. In some such implementations, a vacuum source may be fluidly coupled to a space around the solid TSM.

In some implementations, the TSM and/or the fluid intermediary, is or contains Magnesium. In various implementations, for example, the TSM and/or the fluid intermediary comprises Magnesium Oxide or Magnesia Carbon, either in a solid form or in a liquid form such as a suspension or solution containing these materials.

In yet another aspect, a method includes introducing thermal energy into a thermal storage material (TSM), storing the thermal energy in the TSM; and subsequently removing the stored thermal energy from the TSM, where the TSM is or includes Magnesium (e.g., in the form of Magnesium Oxide or Magnesia Carbon).

In still another aspect, a system includes a thermal storage material (TSM); a means for introducing thermal energy into the TSM (e.g., a heat exchanger); and/or a means for removing stored thermal energy from the TSM (e.g., a heat exchanger). In various implementations, the TSM comprises solid Magnesium Oxide, and/or solid Magnesia Carbon, and/or Magnesium Oxide in a liquid suspension, and/or Magnesia Carbon in a liquid solution, and/or the means for introducing thermal energy into the TSM utilizes solid Magnesium Oxide, and/or solid Magnesia Carbon, and/or Magnesium Oxide in a liquid suspension, and/or Magnesia Carbon in a liquid solution, and/or the means for removing thermal energy from the TSM comprises or utilizes solid Magnesium Oxide, and/or solid Magnesia Carbon, and/or Magnesium Oxide in a liquid suspension, and/or Magnesia Carbon in a liquid solution.

In yet another aspect, in a system comprising a plurality of vessels, each having a storage hold for a liquid thermal storage material (TSM) and an offshore wind generator (e.g., on an offshore platform), a method comprising: positioning a first one of the vessels and a second one of the vessels proximate the offshore wind generator, wherein a first storage hold on the first one of the vessels contains unheated TSM, and wherein a second storage hold on the second one of the vessels is empty; pumping the unheated TSM from the first storage hold on the first one of the vessels through a heater; heating the unheated TSM in the heater with electricity generated by the offshore wind generator to produce heated TSM; directing the heated TSM into the second storage hold on the second one of the vessels; transporting the heated TSM in the second storage hold on the second one of the vessels to a remote location, wherein thermal energy is removed from the heated TSM at the remote location; after the second one of the vessels departs a proximity of the offshore wind generator to transport the heated TSM, positioning a third one of the vessels proximate the offshore wind generator, wherein a third storage hold on the third one of the vessels contains unheated TSM; pumping the unheated TSM from the third storage hold on the third one of the vessels through the heater; heating the unheated TSM in the heater with electricity generated by the offshore wind generator to produce heated TSM; directing the heated TSM into the first storage hold on the first one of the vessels; and transporting the heated TSM in the first storage hold on the first one of the vessels to a remote location, wherein thermal energy is removed from the heated TSM at the remote location.

In yet another aspect, multiple vessels have a single (e.g., one and only one) storage hold for a liquid TSM. At an offshore wind generator, a first one of these vessels (next to the offshore wind generator) has (e.g., arrives at the offshore wind generator with) its storage hold filled with TSM but the TSM in the storage hold of that first vessel is not heated. A second vessel (also next to the offshore wind generator) has an empty storage hold. The cold (or unheated) TSM from the first vessel is pumped to (through) a heater powered by electricity from the offshore wind generator, where it is heated by electricity generated by the offshore wind generator. The heater may be physically coupled to (or on the same platform as) the offshore wind generator (or may be on one of the vessels). The heated TSM is pumped (e.g., by a pump that may be on the offshore wind generator platform, or on one of the first or second vessels) into the empty hold of the second vessel. Once the hold of the second vessel is filled (fully or partially) with the heated TSM, the second vessel may depart the proximity of the offshore wind generator and transport the TSM to a first remote location (e.g., a shoreside plant), where the transported energy can be removed from the TSM in accordance with one or more techniques disclosed herein. At this point the first vessel's storage hold is empty (or at least has some excess storage capacity). A next (e.g., third) vessel, carrying in its hold unheated TSM, takes the place of the second vessel near the offshore wind generator. The unheated TSM from the next (third) vessel may then be pumped to the heater on the offshore wind generator platform, where it is heated using electricity generated by the wind generator, and the heated TSM is flows to the empty hold of the first vessel. Once the first vessel is filled with heated TSM, the first vessel transports the heated TSM to a remote location (i.e., the first remote location or another remote location), and the process begins again with a fourth vessel carrying unheated TSM taking the place of the first vessel near the offshore wind generator, etc. In order to ensure that a large portion of the electricity generated by the offshore turbine is captured as thermal energy and stored in a TSM, the offshore turbine platform in a typical implementation may have either three connection points (e.g., valved threaded connectors that provide entry to fluid communication channels, e.g., pipes) for the vessels, so that the liquid TSM could be immediately redirected to a vessel with an empty hold, or alternatively, the offshore wind turbine platform may have its own storage tank to hold an amount of liquid TSM needed to be heated during the time required for a vessel to disconnect from one of two connection points, and a next vessel connect to that same connection point. The phrase “cold” or “unheated” as used here means that the “cold” or “unheated” TSM has not been pumped through the heater during the current visit to a proximity of the offshore wind generator.

In some implementations, no electrically conductive cables extend between and are used to carry electricity between the offshore wind-powered turbine generator and the shoreside energy conversion station (or if there are any such electrically conductive cables, they may not be used as much, or utilized to the degree, as they otherwise might be).

In yet another aspect, a method is disclosed in the context of a system that includes a plurality of vessels (e.g., boats or ships), each having a storage hold (e.g., a space for carrying cargo) for a liquid thermal storage material (TSM), and an offshore wind generator that the vessels can travel to and from. The method includes positioning a first one of the vessels and a second one of the vessels proximate the offshore wind generator. The first storage hold on the first one of the vessels contains unheated TSM. The second storage hold on the second one of the vessels is empty. The method includes pumping (e.g., with a pump) the unheated TSM from the first storage hold on the first one of the vessels through a heater and heating the unheated TSM in the heater with electricity generated by the offshore wind generator to produce heated TSM. The heated TSM is directed (e.g., via piping or tubing and under the influence of the pump) into the second storage hold onboard the second one of the vessels. The method includes transporting the heated TSM in the second storage hold on the second one of the vessels to a remote location (e.g., a power conversion station or the like) and the thermal energy is removed from the heated TSM at the remote location. After the second one of the vessels departs a proximity of the offshore wind generator to transport the heated TSM, the method includes positioning a third one of the vessels proximate the offshore wind generator. The third storage hold on the third one of the vessels contains unheated TSM. The unheated TSM is then pumped (with the same or a different pump as the previously mentioned one) from the third storage hold on the third one of the vessels through the heater (or a similar but different heater). The unheated TSM is then heated in the heater with electricity generated by the offshore wind generator to produce heated TSM. The heated TSM is then directed into the first storage hold on the first one of the vessels and transported in the first storage hold on the first one of the vessels to a remote location (e.g., the same as the previously-mentioned remote location or a different remote location), where thermal energy is removed from the heated TSM.

In some implementations, one or more of the following advantages are present. For example, in some implementations, the systems and techniques disclosed herein facilitate transmitting energy (e.g., from an offshore wind turbine generator or wind farm to a shoreside electrical power grid) without the need for long electrical cables to carry the energy. The use of electrical cables to carry energy long distances typically has a number of associated problems, including the cost to manufacture and install a specialized type of cable, the long lead time needed to manufacture the cable, potential environmental impacts of installing the cable, and the susceptibility of the cable to damage.

Moreover, the systems and techniques disclosed herein typically provide for cost-effective transmission of electrical energy generated by offshore wind turbines to an on-shore electric power grid by converting the electrical energy while still offshore to thermal energy, storing the thermal energy on a ship or vessel, transporting the stored thermal energy to a grid connection point on or near the shore, converting the stored thermal energy back to electrical energy, and then delivering the electricity to the power grid.

Transmitting electrical energy generated by offshore wind turbines to the onshore electrical grid using submarine cables presents considerable challenge and expense. And yet to date, for lack of better means of transmitting the energy generated, all of the constructed and proposed offshore wind projects that the applicant is aware of have utilized a submarine cable connecting the offshore turbine installation to a substation onshore. Because of the typically long distances (e.g., 40 to 60 miles or more) of the cable route between the offshore wind turbine installation site and the onshore substation interconnection point, an offshore substation is also necessary in order to transform the medium voltage electricity generated by the turbines to a higher voltage sufficient for long-distance transmission. And if the cable route distance is in excess of approximately 60 miles, it may be necessary to convert the alternating current (AC) electricity generated by the turbines to a direct current (DC) in order to achieve effective energy transmission; this conversion to DC requires construction of an offshore converter station that may be even larger and more expensive than an offshore substation. This traditional means of transmitting energy from offshore wind turbines to shore creates the technical hurdles and expenses that include:
Significant cost of fabricating and installing the offshore substation or converter station and the cables. The cost of a traditional energy transmission system can be over 20% of the total cost of an offshore wind farm.
Limited fabrication, manufacturing, and installation capacity globally, which creates risks to successful completion of a project as well as additional risk and expense should repair, or replacement be needed after completion.
Substantial impact of a single point failure to the transmission system. If a system has only one step-up transformer and/or one cable, should that just one transformer or cable fail, none of the energy from the wind turbines can be delivered to the power grid. The traditional resolution to this problem is to install redundant components, which further exacerbates the cost and other impacts of the traditional energy transmission solution.
Energy loss in the electric transmission system due to electrical resistance that can sometimes be as much as 10% of the energy generated by the offshore wind turbines.
Environmental impacts of installing the cables, as well as potential for certain fishing activities to have to be modified in the vicinity of the cable even after installation.

To date, innovations to address these challenges and expenses have included modifications to the use of a submarine cable for energy transmission. For example, larger cables, improved tools for installing submarine cables, and attempts at more efficient design, installation, and fabrication of the offshore substation.

Certain implementations of the energy transmission system and processes described herein do not utilize any submarine cables to transmit the electrical energy to shore.

In addition to avoiding the problems of using cables to transmit energy long distances, transmitting energy by means of storing the energy in a TSM, and then shipping or transporting that TSM containing the energy, can provide benefits to the electrical grid as well. These benefits may include allowing for energy to be put on the electrical grid at times when it is needed most and providing reactive power to the grid in an era when it is needed most due to greater use of inverter-based generation sources such as wind and solar.

Other features and advantages will be apparent from the description and drawings, and from the claims.

### BRIEF DESCRIPTION OF THE DRAWINGS

FIG. 1 is a schematic representation of an exemplary energy transmission system that does not need (or utilize) any submarine cables to transmit electrical energy from an offshore wind farm (made up of one or more offshore wind turbines) to a shoreside electrical power grid.

FIG. 2 is a schematic representation of another exemplary energy transmission system that does not need (or utilize) any submarine cables to transmit electrical energy from an offshore wind farm (made up of one or more offshore wind turbines) to a shoreside electrical power grid.

FIG. 3 is a schematic representation of yet another exemplary energy transmission system that does not need (or utilize) any submarine cables to transmit electrical energy from an offshore wind farm (made up of one or more offshore wind turbines) to a shoreside electrical power grid.

FIG. 4 is a schematic cross-sectional view of an exemplary double-walled thermal storage material (TSM) container and piping.

FIG. 5 is a schematic cross-sectional view of an exemplary single-walled TSM container with an internal rack and piping.

FIG. 6 is a schematic representation of an exemplary system for heating TSM onboard a vessel with electricity generated by an offshore wind turbine generator or wind farm.

FIG. 7 is a schematic representation of another exemplary system for heating TSM onboard a vessel with electricity generated by an offshore wind turbine generator or wind farm.

FIG. 8 is a schematic cross-sectional view of an exemplary TSM container configuration with fluid supply piping at different levels.

FIG. 9 is a schematic representation of an exemplary system that utilizes TSM to store energy, and potentially transfer energy from a heat source to a remote destination.

FIG. 10 is a schematic representation of an exemplary system for transporting energy from a first location to a second (remote) location.

FIGS. 11A and 11B are partial schematic representations of an alternative exemplary system for transporting energy from a first location to a second (remote) location.

FIG. 12 is a partial schematic representation of an alternative exemplary system for transporting energy from a first location to a second (remote) location.

FIG. 13 is a partial schematic representation of an alternative exemplary system for storing energy and/or transporting energy from a first location to a second (remote) location.

FIG. 14 is a partial schematic representation of an alternative exemplary system for storing energy and/or transporting energy from a first location to a second (remote) location.

Like reference characters refer to like elements.

### DETAILED DESCRIPTION

This disclosure relates to systems and techniques for storing thermal energy in a thermal storage material (TSM). While each of these systems and techniques might be used for storing energy in a TSM that is stationary, some of the systems and techniques are likely to be particularly useful for storing energy in a TSM that is then transported, for example by a vessel, and the heat energy then removed from the TSM at a remote location. Such transport of the heated TSM would thereby provide a means for transmitting energy (e.g., from an offshore wind turbine generator or wind farm to a shoreside electrical power grid) without requiring long electrical cables to carry the energy. The disclosure also relates to other concepts that may facilitate the efficient storage and/or transfer of energy (e.g., in the form of heat converted to/from electricity), especially across long distances, without the use of comparably long electrical cables.

Various implementations include one or more of the following features, or combinations thereof:
1. Magnesium or magnesium compounds (e.g., any compound comprising magnesium) as a thermal energy storage material (TSM),
2. Magnesium or magnesium compounds used in a liquid as a thermal energy transfer medium,
3. Using a fluid intermediary to heat or recover heat from a solid TSM,
4. A configuration that uses a fluid intermediary to heat or recover heat from a solid TSM, in which multiple levels of pipes are connected to a container, in which is a solid TSM, and these pipes are used to introduce the fluid intermediary to the TSM starting first at the top of the TSM mass, and then sequentially down to the next level of pipes, and thereby heat the TSM mass starting from the top down,
5. Storing thermal energy using a ‘vacuum bottle’ approach, in which a vacuum or partial vacuum creates a thermal break between the TSM and the environment, by evacuating air from a storage vessel, for example, after the TSM has been heated,
6. Means to store thermal energy using a ‘vacuum bottle’ approach, in which a vacuum or partial vacuum creates a thermal break between the TSM and the environment, by using a double-walled tank with air evacuated between the two walls,
7. A process for enabling a continuous (e.g., uninterrupted), or almost continuous, heating of a TSM on vessels by an electrical generator, by a signaling and control system that allows for immediate switching of heating of a TSM on a vessel that has its TSM fully heated to a vessel whose TSM is not yet heated.
8. A process for transporting a heated liquid TSM between two points using multiple vessels, in which each vessel has only one hold (or container) for the liquid TSM, and the cold TSM from one vessel is transferred from the first vessel, is heated, and then transferred to the empty hold of a second vessel.
9. A process for transporting a heated liquid TSM between two points using multiple vessels, each vessel having two holds (or containers) for the TSM, one of which is typically empty, and in which cold TSM from one hold is heated and then transferred to the second hold on the same vessel.

Each of these, and more, including what follows is disclosed and discussed in various implementations throughout the application.
10. Processes by which energy from a heat source can be stored in the TSM in the holds of a plurality of vessels, the storage process allowing for an immediate and nearly instantaneous switching from storing heat energy in the TSM of a first vessel to storing the energy in the TSM of a second vessel when the TSM on the first vessel has reached its storage capacity (limit), thereby allowing continuous (without interruption) storage of the heat energy and so preventing loss of heat energy from being stored for future use.

In certain implementations, the systems and techniques disclosed herein work as follows:
Electrical energy generated by the offshore wind turbines is delivered to a vessel (e.g., a ship or boat) stationed offshore among or close by to the wind turbines.
The electrical energy is then converted to heat using either electric resistant heaters or by powering a heat pump, or a combination of the two. (Alternatively, the electrical energy could be converted to heat at a location aside from the vessel, e.g., on the turbine foundation, etc., and then that heat energy transferred to the vessel) Heating using electric resistant heaters has the advantages of no moving parts and relatively low component costs, and in theory 100% of the electrical energy can be converted to heat. A heat pump would use compressors and a heat transfer medium to extract heat from the surrounding air or water. The advantage of a heat pump is that since it is extracting heat from the environment, it can store more usable heat energy than is available from simply converting electrical energy to heat, and this could improve the overall efficiency of the system. The disadvantage of a heat pump is that it has moving parts that increases maintenance costs, and also has higher initial component costs. Whether to use electric resistant heaters, heat pumps, or a combination of the two would be a design decision dependent on the specifics of each unique application of the system.
The heat is then applied to a thermal storage material (TSM) on the vessel, thereby storing the heat energy in the form of higher sensible heat. In addition to storing heat in the form of sensible heat increase, heat could also be stored in the form of latent heat needed for a phase change in the TSM (e.g., melting the TSM from a solid state to a liquid state). The general design of the system would be similar whether or not a phase change is utilized for storing heat. The most significant difference would be that in the case of a system using a phase change, the vessel holding the TSM would need to contain the TSM in both phases (e.g., in both a solid and liquid phase), and the components that store and extract the heat from the TSM would likewise need to work regardless of which phase the TSM was in. A large number of different materials could be used for the TSM including rocks, sand or pellets, salt, oils/waxes, air (including systems that use combinations of compressed air and/or vapor in the air that undergoes a phase change), water (or water solutions), or concrete.
Temperature, pressure, and other sensors integral to the TSM storage on the vessel would be utilized to determine the amount of heat energy stored in the TSM at any time, including during the processes of storing or discharging the heat energy. The amount of thermal energy in a material is a function of its temperature, pressure, phase, and the amount (mass) of the material. So, any sensors measuring any of these parameters would or could be used to determine total amount of energy contained in a TSM system.
The vessel and its TSM storage could be designed with thermal insulation between the

TSM and the environment, so as to minimize inefficiencies created by heat stored in the TSM being lost to the environment.
Once the TSM stored on the vessel has been charged with thermal energy, the vessel travels to a harbor location where the thermal energy is converted back to electrical energy by one or more of several means that could include generating steam to drive a steam turbine, Sterling engines, or thermocouple devices. The electrical energy is then delivered to the onshore grid by standard utility practices similar to any other power plant. Heat energy that cannot be used for generating electricity could be utilized as heat, for example in industrial processes or for space heating.
Once the thermal energy on the vessel has been discharged, the vessel can return to the offshore wind farm site to be recharged, and the process starts again. More than one vessel can be utilized so that at least one vessel is able to receive energy from the offshore wind turbines at any time. The amount of heat energy stored offshore at the wind farm, and the amount of heat energy that is then discharged on-shore to generate electricity, would be dependent on the thermal storage characteristics of the TSM and operational considerations including the number of vessels being utilized, the price being paid for the electricity generated, and the sailing time between the point of discharge on-shore and point of charging offshore.
The vessel(s) could be obtained by modifying existing vessels for this specialized purpose of this system. For example, a petroleum tanker could be modified to hold the TSM, and the piping system originally intended to load and unload the petroleum product could be modified for the purpose of generating and collecting steam that would drive an electrical generator. The vessels could also be specially designed and built for the purpose of this system. A purpose-built vessel may be able to achieve greater efficiencies than a modified vessel, for example by achieving greater thermal insulation between the TSM and the environment or being able to remain offshore during more inclement weather. The vessels could be self-propelled or take the form of a barge and need to be pushed and/or pulled for transport. To increase the efficiency of the overall system, the vessels could be designed to remain on station for extended periods offshore, including in a wide range of weather conditions, and with minimal operational costs while stationed offshore. For example, the vessel could utilize telecommunications, vessel dynamic positioning systems, and robotics and/or artificial intelligence technologies to monitor and maintain the vessel on station and the charging process, so that the vessel's TSM could be charged offshore without any crew, or very few crew, needing to remain on the vessel during the charging process. Another example would be for the vessels to have mooring cable or chain handling systems that can quickly and securely attach to a multi-point anchored mooring offshore, so that the vessel does not need to set an anchor every time it arrives at the charging station or continuously rely on a vessel dynamic positioning system. Another example would be a vessel with semi-submersion or large ballasting capabilities, so that the vessel could lower itself deep enough into the water to withstand large waves and/or high winds. Design features such as these would ensure that energy from the turbines could be stored on the vessel even during extreme weather which might otherwise prevent a vessel from being stationed at the wind turbine site. The vessels could also be designed to support other functions necessary for the wind turbines' operations in addition to energy transmission. For example, the vessel could transport and house technicians who need to access the turbines for maintenance or repair. A set of multiple vessels with differing designs could be utilized to service any given offshore wind farm generation station, so as to benefit from the full range of capabilities of the various design options and the specific circumstances of the generation station (e.g., distance from shore, local weather conditions, availability of tugboats in the area, etc.). A fleet of TSM vessels could be available to service multiple offshore wind farms, providing for redundancy and therefore higher reliability of service, and also cost-savings through economies of scale and greater total operational experience.
Overall economic efficiency of an offshore wind farm could be improved by combining the vessels utilized for energy transport, described above, with the need for vessels to service the wind turbines regardless of the means of energy transmission. Typically, several purpose-built vessels are utilized to transport and house wind turbine technicians, with their equipment and supplies, to the offshore wind turbines. By instead shipping and housing the technicians, and their equipment and supplies, on the energy transport vessels total overall vessel construction and operation costs for an offshore windfarm could be reduced.

In a typical implementation, this electrical energy transmission system for offshore wind farms entails converting the electrical energy to a different energy form, heat, and then transporting the heat energy to the desired delivery point of the electrical energy. This is distinct from the routine vessel transportation of stored chemical energy, such as liquid or gas hydrocarbons or hydrogen, which is not done for the purpose of transmitting electrical energy.

A typical system is also distinct from other processes that transform thermal energy to electricity. For example, molten salts are heated and cooled in concentrated solar power (CSP) plants for electricity generation. However, in the case of CSP the thermal energy captured in the molten salt is used as part of the process to generate electricity in the first instance and is not in any way relevant to the transmission of the electricity once it is generated by the CSP plant. For another example, stored thermal energy has also been proposed as a means to balance electrical energy supply and demand on an electric grid. However, in this application the thermal energy is not in any way transported, let alone transported between a remote electric generator and the power grid. Rather, the heat energy is stored in material that is permanently located at a position convenient for having a continuous connection to the power grid.

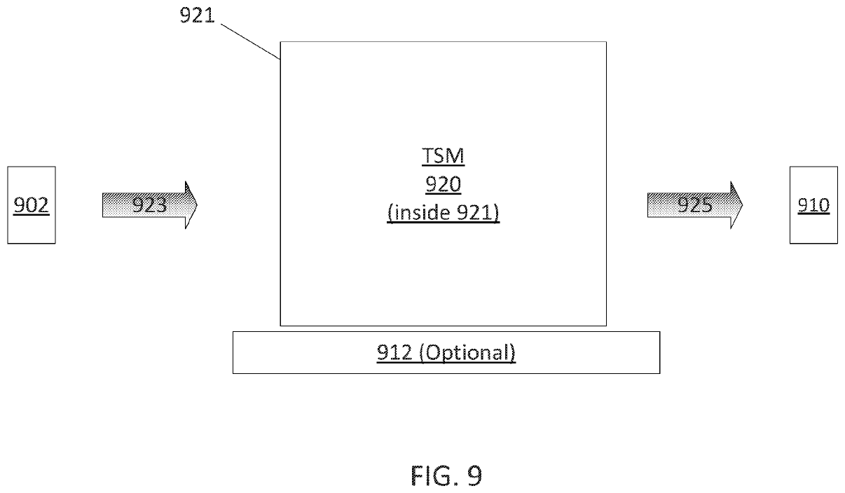

FIG. 9 is a schematic representation of an exemplary system 900 for storing and optionally transporting thermal energy in a thermal storage material (TSM) 920.

The illustrated system 900 includes a heat source 902, an (optional) transport vehicle 912, the TSM 920 (that is shown, in the illustrated implementation, as being atop the transport vehicle), a means 923 for introducing thermal energy into the TSM 920, and a means 925 for removing the thermal energy from the TSM 920 so that it can be utilized (e.g., by a machine or process) for some practical application 910. According to the illustrated implementation, heat or thermal energy is transferred from the heat source 902 and into the TSM 920 for storage. The TSM 920, with the stored thermal energy, may be kept in one location for the entire time that the thermal energy is being stored, or it may be moved from a first location (where the thermal energy was transferred into the TSM) to a second (remote) location (where the thermal energy can be removed from the TSM 920 and made available for the practical application 910).

The TSM 920 typically is stored in a container 921. In various implementations, the container 921 can be virtually any kind of container that is able to hold the TSM. In some implementations, the container 921 is air-tight. However, the container 921 also allows energy to be transferred from an external heat source into the TSM 920 via thermal energy transfer means 923 and allows energy to be removed from the TSM 920 and from the container 921 via thermal energy transfer means 925. The energy transferred into the TSM manifests as heat (or stored thermal energy) in the TSM. However, the energy can take virtually any form (heat, electricity, etc.) before being transferred into the container 921 and TSM 920, and/or while being transferred into or out of the TSM 920 or the container 921, and/or after being transferred into or out of the TSM 920 or the container 921.

The energy source can be virtually any kind of energy source and the means for transferring energy into or out of the TSM and/or through the container can be virtually any deliberate way of transferring the energy (e.g., using one or more machines and/or other man-made structures to facilitate the energy transfer). For example, in some implementations, the energy is transferred through the container 921 and into (or out of) the TSM 920 as heat within a fluid (flowing, e.g., through a pipe or other fluid communication channel). The fluid may be a liquid or a gas. In some implementations, the heated fluid, once inside the container 921, flows through the container 921, giving up heat to the TSM 920 by coming into direct physical contact with the TSM 920. For example, the fluid, if liquid, may flow directly over the TSM 920 and, thereby, heat up the TSM. In some implementations, there are pipes or other structures inside the container 921 that define one or more fluid communication paths for the heated fluid that pass through or near the TSM so that heat from the heated fluid can pass through the pipes or other structures and into the surrounding or nearby TSM. Once the heated fluid gives up heat to the TSM 920, the heated fluid exits the container 921 through a heated fluid outlet port.

The heated fluid (delivered into the container 921) can be heated in any one of a wide variety of ways. For example, the heated fluid can be heated by any kind of heater-an electric heater (e.g., with one or more electric resistance heating elements that rely on electricity to produce heat that heats the fluid), a solar heater (e.g., with one or more solar thermal collectors that uses sunlight to produce heat that heats the fluid), a gas heater (e.g., that heats the fluid by burning natural gas, liquified petroleum gas, propane, or butane), a gasoline heater (e.g., that heats the fluid by burning gasoline), a kerosene heater (e.g., that heats the fluid by burning kerosene), a geothermal heater (e.g., that uses geothermal energy to heat the fluid), a heater that utilizes volcanic heat to heat the fluid, etc.

Alternatively, the energy can be transferred through the container 921 and into the TSM 920 in the form of electricity that ultimately passes through one or more electric heaters (e.g., electrical resistance heaters) inside the container 921. The electric heaters can be near (e.g., thermally coupled to) or touching (i.e., in direct physical contact with) the TSM 920 inside the container 921. In some implementations, multiple electrical resistance heaters may be positioned around the inside of the container 921-some or all of which may be touching the TSM, some or all of which may be near (but not in direct physical contact with) the TSM.

The electricity, whether used to heat the TSM or to heat an intermediary fluid that is then used to heat the TSM, can be produced or provided in any number of ways. Some examples of sources of electricity include electrical generators, solar (or photovoltaic) cells, and batteries. Electrical generators can be driven by any one of a variety of different types of prime movers (e.g., engines). Some examples of prime movers for electrical generators include wind turbines, steam turbines, steam engines, gasoline engines, diesel engines, water turbines, etc.

With a system that utilizes a geothermal heat source, thermal energy from the Earth is utilized to heat the TSM, directly or indirectly. In one exemplary implementation, a system that utilizes geothermal energy in the heat source 902 would include an inground heat exchanger (e.g., a series of pipes) and an above-ground pump to circulate fluid through the inground heat exchanger. Heat from the Earth would be transferred into the circulating fluid and then transferred above-ground into the TSM. The above-ground transfer of heat from the heated fluid into the TSM can be accomplished in any number of potential ways. For example, the heated fluid may be circulated through a series of pipes within and thermally coupled to the TSM. Alternatively, the heated fluid can be used to heat air that gets passed over or through the TSM. In those instances, the heated fluid may be directed through a series of pipes that a fan blows air over. The air gets heated as it passes over the pipes and then passes over or through passages in the TSM. Heat from the heated air then transfers into the TSM. Other ways of transferring heat from the Earth into TSM are possible as well. A system that utilizes a volcanic heat source may be like a system that utilizes a geothermal heat source, except the heat exchanger would be located near, and thermally coupled to heat stored in, a volcano.

The TSM 920 in the illustrated implementation is on the transport vehicle 912. The transport vehicle 912 can be virtually any kind of vehicle configured to move the TSM 920 from one location to another. Examples of transport vehicles 912 include ships, boats, trains, trucks and other self-propelled wheeled vehicles, planes, vessels, etc. as well as vehicles that might be towed or pushed, e.g., train cars or barges. In a typical implementation where the TSM is to be transported, heat is transferred into the TSM at a first location (e.g., at the heat source 902, which may be an offshore wind farm, for example) and then transported (by the transport vehicle 912) to a second location (e.g., to a shoreside energy station 910, where heat is removed from the TSM and used for a practical application, e.g., to contribute to making steam for a shoreside steam turbine generator or for a shoreside heating application).

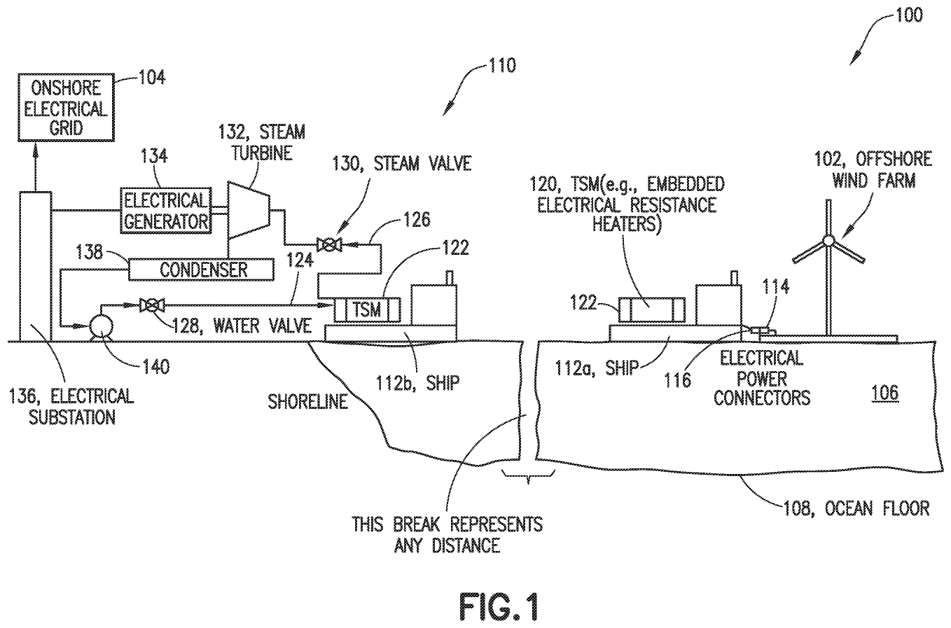

The energy station 910 mentioned in connection with any other example disclosed herein can be virtually any kind of component or collection of components configured to convert heat from the TSM into some other form (e.g., electricity, etc.) or otherwise utilize the heat from the TSM for a useful purpose (e.g., heating). In some implementations, the energy system 910 includes a pump and a series of pipes configured to pump a fluid (e.g., liquid or gas) through or past the TSM to draw heat from the TSM. This may decrease the heat of the TSM. The heated TSM is then utilized (e.g., to heat something else). In some implementations, the energy station 910 is configured like the energy conversion station 110 of FIG. 1 to convert the thermal energy drawn from the TSM into electricity. In a typical implementation, after the thermal energy has been removed from the TSM (at energy station 910), the transport vehicle 912 returns the TSM to the heat source 902 or to some other heat source (not shown in FIG. 9) to pick up more heat for storing or being transported.

The TSM 920 in FIG. 9 (and elsewhere herein) can be (or include) any kind of TSM. In a typical implementation, the TSM 920 is or includes magnesium. It could be elemental magnesium or compounds of magnesium like magnesium oxide or magnesia carbon. The amount of magnesium or magnesium-containing compounds (e.g., magnesium oxide or magnesia carbon) in the TSM can vary. However, typically, there is more than trace amounts of amounts magnesium or magnesium-containing compounds in the TSM. For example, in various implementations, the amount of magnesium or magnesium-containing compounds (e.g., magnesium oxide or magnesia carbon) in the TSM may be greater than 30%, greater than 40%, greater than 50%, greater than 60%, greater than 70%, greater than 80%, greater than 90%, or 100%. In some implementations, the TSM 920 is or includes a liquid suspension with solid Magnesium Oxide and/or solid Magnesia Carbon, and/or Magnesium Oxide.

Another way of viewing the system of FIG. 9 is as a system that includes a thermal storage material (TSM), a means for introducing thermal energy into the TSM, and a means for removing stored thermal energy from the TSM. The means for introducing the thermal energy can include any one or more of the structures or fluids/suspensions, or combinations thereof for transferring thermal energy (heat) into the TSM disclosed herein. In some implementations, the means for introducing thermal energy into the TSM comprises or utilizes solid Magnesium Oxide, and/or solid Magnesia Carbon, and/or Magnesium Oxide in a liquid suspension, and/or Magnesia Carbon in a liquid solution. The means for removing the thermal energy can include any one or more of the structures or fluids/suspensions, or combinations thereof for transferring thermal energy (heat) out of the TSM disclosed herein. In some implementations, the means for removing thermal energy from the TSM comprises or utilizes solid Magnesium Oxide, and/or solid Magnesia Carbon, and/or Magnesium Oxide in a liquid suspension, and/or Magnesia Carbon in a liquid solution. Other options for the TSM, the means for introducing thermal energy, and/or the means for removing the stored thermal energy are possible (and can be based on any other descriptions of similar systems and technologies described herein or otherwise known in the industry). In various implementations, the system in FIG. 9 could be used to transport energy from a remote source to a destination. In various implementations, the foregoing system could be used to store thermal energy without moving it at all (e.g., for later use at the same location). In various implementations, the thermal energy introduced into the TSM can derived from any source including, for example, an electrical source. In various implementations, the thermal energy removed from the TSM can be applied to any practical use including, for example, by converting it into an electrical source after being stored.

In an exemplary implementation, the foregoing system is comprised of three elements: 1) The TSM (e.g., Magnesium Oxide and/or Magnesia Carbon), 2) a means of introducing thermal energy into the TSM (e.g., using (in part) the same materials as the TSM itself), and 3) a means of removing TSM (e.g., using (in part) the same materials as the TSM itself). To be clear, the system may include any one or two of these three elements without the others. In one example, the system may use Magnesium Oxide as a TSM, even if the means of delivering and recovering the thermal energy into/from the TSM is or uses air or water.

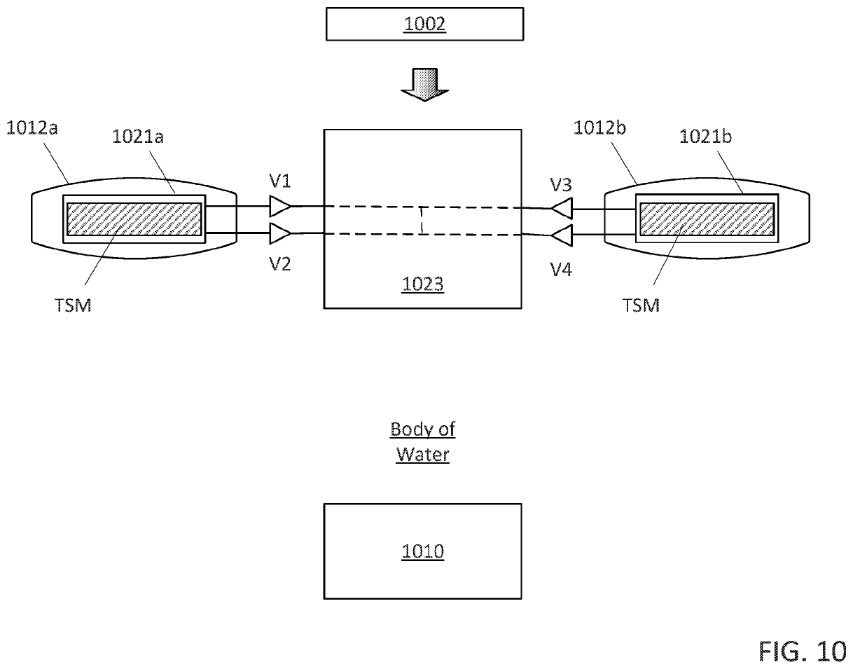

FIG. 10 shows an exemplary system that includes a plurality of ships 1012a, 1012b, each of which is carrying a container 1021a, 1021b, of thermal storage material (TSM), typically a solid material (e.g., containing magnesium). There are only two ships shown in the illustrated implementation. It should be understood, however, that a typical implementation may include several or many other ships similarly configured-i.e., carrying containers of TSM.

The ships 1012a, 1012b in the illustrated implementation are next to a platform of an offshore wind farm. Onboard the platform is an energy source 1002 (e.g., a wind turbine generator that produces electricity for heating) and a heat exchanger 1023 to transfer energy from the energy source 1002 into an intermediary fluid that is transferred to the TSM onboard the vessels 1012a, 1012b. In this regard, fluid communication channels extend from the TSM container 1021a, 1021b on each ship 1012a, 1012b to the heat exchanger 1023 via fluid communication channels (e.g., pipes) with valves V1, V2, V3, V4 to control flow through the fluid communication channels. In a typical implementation, the fluid communication channels are easy to establish and terminate—e.g., by connecting and disconnecting hoses, tubing, or piping, etc., between the containers 1021a, 1021b on the ships 1012a, 1012b and the heat exchanger 1023 on the platform. Thus, when a ship first arrives at the platform, the connections can be made to establish the fluid communication channels between that ship's TSM container and the heat exchanger 1023 on the platform. Likewise, when the ship is ready to depart the platform, the connections can be broken to terminate the fluid communication channels between that ship's TSM container and the heat exchanger 1023 on the platform, thereby freeing the ship to sail away from the platform (e.g., to a remote destination 1010, such as a shoreside energy conversion station where the thermal energy can be converted into electricity or used for space heating or used for some other practical purpose).

The heat exchanger 1023 has internal fluid communication channels that are represented schematically by the dashed lines in FIG. 10. The fluid communication channels can be established as shown in FIG. 10-with a first set of fluid communication channels extending between the TSM container 1021a on ship 1012a and the heat exchanger 1023, and a second set of fluid communication channels extending between the TSM container 1021b on ship 1012b and the heat exchanger 1023. In that configuration, if valves V1 and V2 are open and valves V3 and V4 are closed, then a first fluid flow loop is established between the TSM container 1021a on ship 1012a, through a first one of the open valves (e.g., V1), through the heat exchanger 1023, and through a second one of the open valves (e.g., V2). Fluid can be circulated through the resulting fluid flow loop with a pump (not shown in FIG. 10).

In that configuration, flow is prevented between the TSM container 1021b on the second ship 1012b and the heat exchanger 1023 by valves V3 and V4, which are closed. However, the fluid communication channels between the TSM container 1021b on the second ship 1012b and the heat exchanger 1023 are established. Therefore, the transfer of thermal energy from thermal energy source 1002 (via the intermediary fluid) can be redirected easily and quickly from the TSM in container 1021a on the first ship 1012a to the TSM in container 1021b on the second ship 1012b as soon as the TSM in container 1021a on the first ship 1012a is fully charged (heated). All that would be needed to do this would be to switch over the valving (to open V3 and V4 and close V1 and V2) and, if a different pump is needed, then to switch over to the different pump, too. It is noted, however, that the system could be configured (with appropriate piping and valving) to use the same pump regardless of which set of valves is being used.

In some implementations, aspects of the system shown in FIG. 10 could be automated. For example, one or more temperature monitors (not shown) may be provided to monitor one or more temperatures in each of the TSM containers and to provide temperature signals to a controller (not shown) that can control the positions of the valves VA, V2, V3, V4 so that the valves switch over automatically when temperature data from one or more of the temperature sensors indicate that a threshold temperature has been reached in the TSM container.

Thus, in a typical implementation, in the system of FIG. 10, the energy source 1002 on the platform provides energy that can be (and is) transferred into an intermediary fluid in the heat exchanger 1023. Multiple ships 1012a (or other movable vessels) travel to and from the platform. Each ship 1012a carries one or more containers 1021a of TSM (e.g., a solid material containing magnesium). The intermediary fluid is circulated into the TSM container onboard whichever ship is configured to receive the intermediary fluid (as determined by the connections to the heat exchanger, the positions of the valves, etc.). Thermal energy is passed from the intermediary fluid into the TSM (e.g., by flowing over and in direct physical contact with the TSM or by flowing through fluid communication channels inside the TSM container, etc.). After giving up heat to the TSM in the container, the intermediary fluid circulates back to the heat exchanger 1023 where it picks up heat from the energy source 1002. The intermediary fluid then travels back to the TSM container to continue heating. The intermediary fluid continues circulating in this manner until the TSM is fully heated (e.g., until temperature readings from temperature monitor(s) for the TSM container indicate that a threshold temperature has been reached), thereby establishing a load of heated TSM in the TSM container.

The valves for that fluid communication loop can then be closed and the valves for the standby vessel can be opened such that the transferring of thermal energy gets immediately and with minimal interruption redirected to the TSM onboard the standby vessel (e.g., 1012b). The ship with the now fully-charged load of TSM can terminate/disconnect all connections to the heat exchanger and platform and depart the platform for the remote destination 1010. The system operates in a similar manner to establish a second load of heated TSM in the TSM container 1021b on the second ship 1012b. This happens while the first load of heated TSM is being physically transported to the remote destination, and/or while the first load of heated TSM is being utilized at the second location, and/or while the first ship 1012a is returning to the platform (or going somewhere else).

Once the TSM onboard the second ship 1012b is fully charged and disconnects from the platform, that ship 1012b physically transports the heated TSM from the platform to the remote location (or to some other location where the thermal energy in the heated TSM can be put to a practical use). Once at its intended destination, the thermal energy is removed from the TSM onboard the second ship 1012b and put to its intended practical purpose.

Meanwhile, while the system was charging the TSM onboard the second ship 1012b, a third ship (not shown in FIG. 10) may have arrived at the platform, or the first ship 1012a may have returned (after discharging its TSM's thermal energy at the remote destination). This ship that arrived at the platform while the second ship's TSM was being charged may establish the same connections to the heat exchanger 1023 that are shown from TSM container 1021a in FIG. 10 so that that ship's TSM can start receiving a charge of thermal energy from the heated intermediary fluid as soon as the second ship's TSM is fully charged.

It should be understood that the system represented in FIG. 10 can be utilized with any number of ships carrying containers of TSM to efficiently switch from ship to ship to transfer energy into the different containers of TSM on those ships. If a ship with unheated TSM is properly connected in a standby configuration (e.g., as discussed above), then the transfer of thermal energy from the thermal energy source 1002 on the platform into mobile TSM can be practically uninterrupted. With enough ships, the availability of heat storage capability can be maintained essentially constantly (more than 99% of the time), enabling storage of all heat energy that is intended to be stored. In a typical implementation, this very nearly constant and practically uninterrupted energy transfer makes the system highly efficient and attractive from an efficiency point of view.

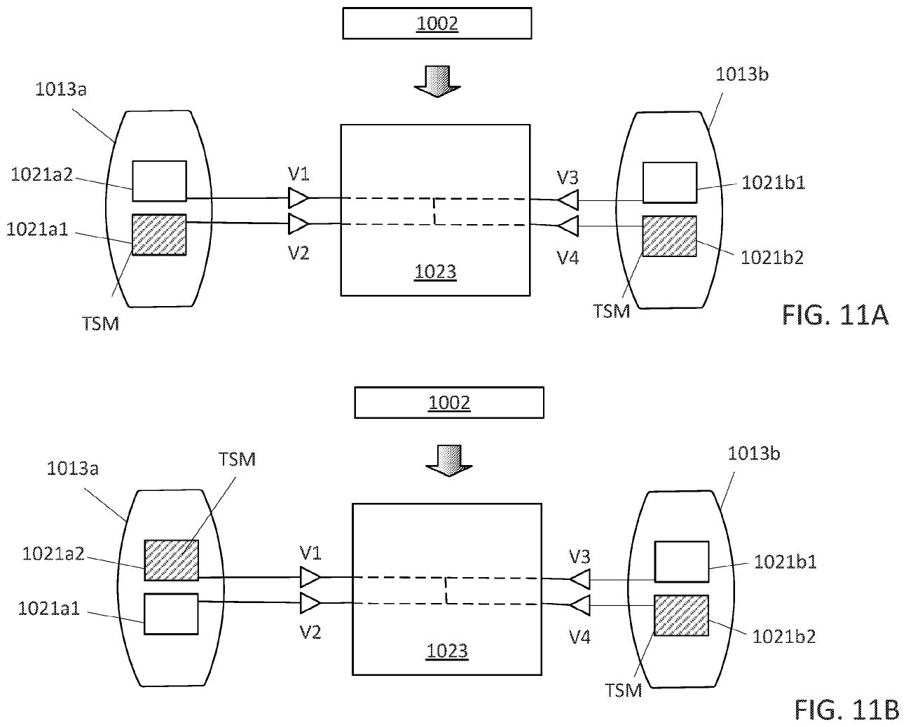

FIGS. 11A and 11B are partial views of a system (at two different points in time) that is similar to the system in FIG. 10. The configurations of the ships 1013a and 1013b in the system of FIGS. 11A and 11B, however, are different than the configurations of the ships in FIG. 10. The fluid connections in the system of FIGS. 11A and 11B are a bit different too.

Each ship 1013a, 1013b in the system of FIGS. 11A and 11B has two onboard containers for TSM. Typically, however, only one or the other, but not both, of the containers is filled with TSM (in a liquid form and containing magnesium). The other container, which is not filled with TSM, is empty. The system is operational such that the liquid TSM from the filled container on a ship is passed through the heat exchanger on the wind farm platform and then back to the previously empty container on the same ship. Thus, unheated liquid TSM from one container on the ship is heated by the heat exchanger on the platform and then returned for storing in a different container on the same ship.

Referring specifically to FIG. 11A, the system shows two containers 1021a1, 1021a2 and 1021b1, 1021b onboard two different ships 1013a, 1013b connected to the heat exchanger 1023. Container 1021a1 onboard ship 1013a is filled with the unheated liquid TSM, whereas container 1021a2 is empty. The fluid communication path between the ship 1013a and the heat exchanger 1023 includes a first portion between container 1021a1 and the heat exchanger (via valve V2) and a second portion from container 1021a2 and the heat exchanger (via valve V1). Similarly, the fluid communication path between the ship 1013b and the heat exchanger 1023 includes a first portion between container 1021b1 and the heat exchanger (via valve V3) and a second portion from container 1021b2 and the heat exchanger (via valve V4).

With the system configured as shown, with valves V1 and V2 in an open position (and valves V3 and V4 in a closed position) the unheated liquid TSM from the initially-filled container 1021a1 on the ship 1013a can be (and is) pumped (with a pump, not shown) through the heat exchanger 1023 to absorb heat from the energy source 1002 and back into the initially-empty container 1021a2 on the same ship 1013a. Thus, the container 1021a1 that was initially filled with unheated liquid TSM ends up empty and the container 1021a2 that was initially empty ends up filled with heated liquid TSM. This is shown in FIG. 11B.

Meanwhile, the other ship 1013b is on standby, connected to the heat exchanger on the platform as shown, and waiting for the first ship 1013a to finish converting all its initially unheated liquid TSM (shown in container 1021a1 in FIG. 11A) into heated liquid TSM (shown in container 1021a2 in FIG. 11B). Once that happens, the valve configurations, etc. can be switched over to quickly and efficiently redirect thermal energy transfer into the TSM onboard the second ship 1013b. Meanwhile, the first ship 1013a with the now fully-charged load of TSM (in container 1021a2) can terminate/disconnect all connections to the heat exchanger 1023 and the platform and depart the platform for a remote destination where the thermal energy in the TSM can be put to a practical use.

In a typical implementation, switching between heating the TSM of the first ship 1013a and heating the TSM of the second ship 1013b occurs as soon as all the TSM from the first ship 1013a has been heated (and stored as heated TSM in container 1021a2). In some implementations, the switch may be performed by hand. In some implementations, the switch occurs automatically (e.g., when a fluid level sensor in one or more of the containers 1021a1/1021a2 signal a controller that the heating/TSM transfer operation is complete). In either scenario, the switching may occur immediately (e.g., without the introduction of any deliberate delay) to facilitate the continuous, or near continuous, transfer of thermal energy from the heat source to TSM that can be moved elsewhere in containers onboard movable vessels.

The system operates in a similar manner to establish a second load of heated TSM in the TSM container 1021b1 on the second ship 1013b. This may happen while the first load of heated TSM is being physically transported to the remote destination, and/or while the first load of heated TSM is being utilized at the second location, and/or while the first ship 1013a is returning to the platform (or going somewhere else).

Once the TSM onboard the second ship 1013b has been fully charged and disconnects from the platform, that ship 1013b can (and does) physically transport the heated TSM (that would be in container 1021b1 at that point) from the platform to the remote location (or to some other location where the thermal energy in the heated TSM can be put to a practical use). Once at its intended destination, the thermal energy is removed from the TSM onboard the second ship 1013b and put to its intended practical purpose.

Meanwhile, while the system was charging the TSM onboard the second ship 1013b, a third ship (not shown in FIG. 10) may have arrived at the platform, or the first ship 1013a may have returned (after discharging its TSM's thermal energy at the remote destination). This ship that arrives at the platform while the second ship's TSM was being charged may establish the same connections to the heat exchanger 1023 as those shown for ship 1013a in FIG. 11A.

As in the system of FIG. 10, it should be understood that the system represented in FIG. 11A and 11B can be utilized with any number of ships carrying containers of TSM to efficiently switch from ship to ship to transfer energy into the different containers of TSM on those ships. If a ship with unheated TSM is properly connected in a standby configuration (e.g., as discussed above), then the transfer of thermal energy from the thermal energy source 1002 on the platform into mobile TSM can be practically uninterrupted. With enough ships, the capacity to store thermal energy at any anticipated rate of energy production can be maintained almost constantly. In a typical implementation, this almost constant and practically uninterrupted energy transfer makes the system highly efficient and attractive from an efficiency point of view.

It should be noted that the systems (e.g., in FIGS. 10, 11A and 11B) are not limited to systems with ships on water (but could be applicable to any movable vehicles in any type of medium).

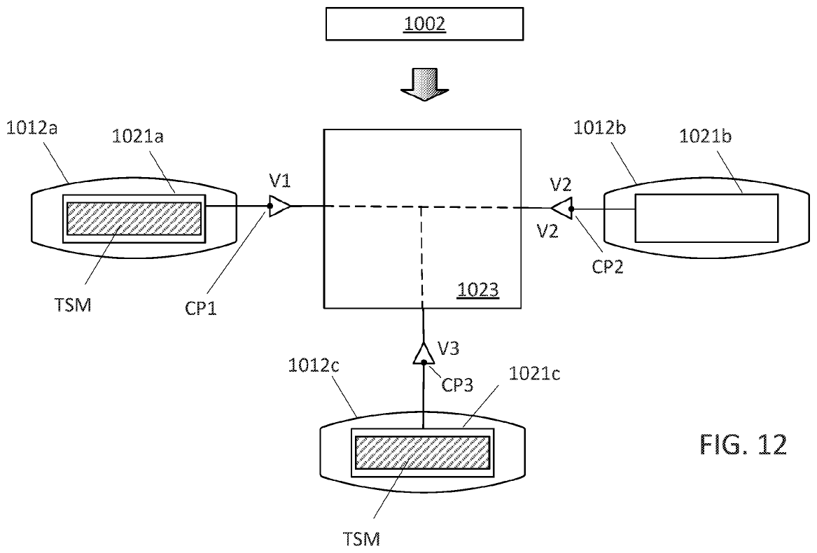

FIG. 12 shows a system that is similar to the system in FIG. 10. There are some exceptions, however. First, for example, the system in FIG. 12 has three ships 1012a, 1012b, 1012c that are next to and tied off to the platform where the heat exchanger 1023 is located. Each of these ships 1012a, 1012b, 1012c have containers 1021a, 1021b, 1021c that are shown as having been piped up to (or fluidly connected to) the heat exchanger via the illustrated fluid communication paths. In this regard, the system has three connection points CP1, CP2, CP3, to which piping or other fluid conveying lines (e.g., hoses, tubes, etc.) can be connected to establish the indicated fluid communication channels that extend between the heat exchanger 1023 and the containers 1021a, 1021b, 1021c onboard the different ships 1012a, 1012b, 1012c. More specifically, each connection point CP1, CP2, CP3 has one and only one fluid conveying line connected to it and extending to a corresponding one of the containers 1021a, 1021b, 1021c. In some implementations, the connection points CP1, CP2, CP3 are positioned near one another and may be arranged together as part of a manifold. This manifold may allow for the creation of a plurality of fluid channels among any of either the connection points CP1, CP2, CP3, and/or the heat exchanger 1023, or other elements described herein.

The illustrated system, therefore, has a portion of the fluid communication channel that extends as shown between each respective one of the containers 1021a, 1021b, 1021c to the heat exchanger 1023, with a valve V1, V2, V3 provided in each portion of the fluid communication channel to control fluid flow through that portion of the fluid communication channel. A portion of the fluid communication channel extends through the interior of the heat exchanger 1023 as shown schematically in the figure. The heat exchanger 1023, in a typical implementation, is configured to transfer heat into any fluid that passes through it (in this regard, the specific fluid path(s) and internal configuration of the heat exchanger can vary considerably).

In the illustrated implementation, the container 1021a on the first ship 1012a is full of unheated liquid TSM (e.g., containing magnesium), the container 1021b on the second ship 1012b is empty, and the container 1021c on the third ship 1012c is full of unheated liquid TSM. Valves V1 and V2 are in an open position, while valve V3 is in a closed position. In this configuration, the liquid TSM from container 1021a on the first ship 1012a can be (and is) pumped (with a pump, not shown) through the heat exchanger, where the liquid TSM is heated, and then to the initially-empty container 1021b on the second ship 1012b (via valves V1 and V2). Once the container 1021b on the second ship 1012b is full of heated liquid TSM, the valve positions can be switched, and the operation of the pump changed, to redirect the flow of TSM through the heat exchanger. More specifically, valve V2 can be closed, valve V3 can be opened, and valve V1 can be left open.

At this point, the initially-unheated liquid TSM in container 1021c can be pumped (with a pump, not shown), through the heat exchanger 1023 where it is heated, and then to the recently-emptied container 1021a (through valves V3 and V1) on the first ship 1012a. Meanwhile, the second ship 1012b disconnects from connection point CP2 and otherwise disconnects and/or pushes off from the platform where the heat exchanger 1023 is located. The second ship 1021b departs the platform for a remote destination where the thermal energy in the heated liquid TSM can be put to a practical use. Then, the second ship 1012b may be replaced with a fourth ship to keep the thermal energy transfer process continuing. The process illustrated by FIG. 12 can be repeated indefinitely, allowing for ongoing and uninterrupted storage and transfer of thermal energy.

Once the container 1021a on the first ship 1012a is full of heated liquid TSM, the valve positions can be switched again, and the operation of the pump changed, to redirect the flow of TSM through the heat exchanger once again. The first ship 1012a disconnects from connection point CP1 and otherwise disconnects and/or pushes off from the platform where the heat exchanger 1023 is located. The first ship 1021a departs the platform for a remote destination where the thermal energy in the heated liquid TSM can be put to a practical use.

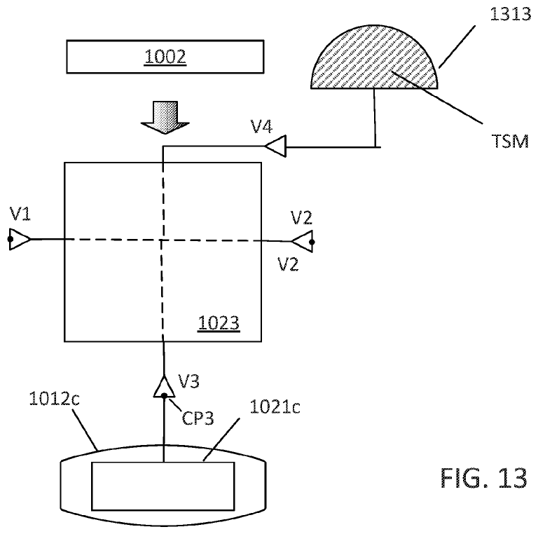

FIG. 13 is a schematic representation of a system that is similar to the system in FIG. 12, except there is only one ship 1012c with an empty container 1021c connected to the heat exchanger 1023 (through valve V3) and there is a liquid TSM storage container 1313 co-located with (e.g., on the same platform as or otherwise at the same facility or physical location as) the heat exchanger 1023. The liquid TSM storage container 1313 contains a liquid TSM (e.g., that contains magnesium) and is handy in situations such as the one represented in FIG. 13, when there is a ship with an empty container ready to be loaded up with heated liquid TSM at the platform, but no ship with a full container of liquid TSM ready to unload. In that situation, the unheated liquid TSM from storage container 1313 can be (and is) pumped (with a pump, not shown) through the heat exchanger (via the fluid communication schematically illustrated in FIG. 13), where it becomes heated, and then to the container 1021c on the ship 1012c. Once the container 1021c on the ship 1012c is full of heated liquid TSM, the ship 1012c can disconnect from the heat exchanger and platform and sail off to a remote destination, where heat from the heated TSM can be removed and put to use in a practical application. Once the container 1021C on the ship 1012c is full of heated liquid TSM, in some implementations, the storage container 1313 will then be fully or partially empty. In some implementations the storage tank 1313 is refilled with unheated TSM by means of a ship with a container of unheated TSM (not shown) attaching to any one of the valves (e.g., valves V1, V2, V3, or V4), and then pumping the liquid TSM using a pump (not shown), from the container on the ship (not shown) through a manifold that creates a communication line (not shown) to storage tank 1313, and into storage tank 1313. In some implementations, the storage tank 1313 is refilled with heated TSM.

It should be understood that once the storage container 1313 has been emptied one of at least two things could happen for energy storage within the container 1313 to continue: 1) a vessel with unheated TSM connects, the TSM is heated (e.g., by the heat exchanger), and the heated TSM goes into the now empty storage container 1313, or 2) two vessels connect, one with unheated TSM and one with an empty container, and the process described herein in connection with FIG. 12 picks up again. Thus, once the storage tank 1313 has been emptied of TSM, there are at least two options: 1) refill it with unheated TSM so that you can later repeat the process described above, or 2) leave it empty so that if there is a scenario in which there is a vessel with unheated TSM connected to the heat exchanger but no vessel with an empty container connected, the first vessel has a place to store the heated TSM as it becomes heated.

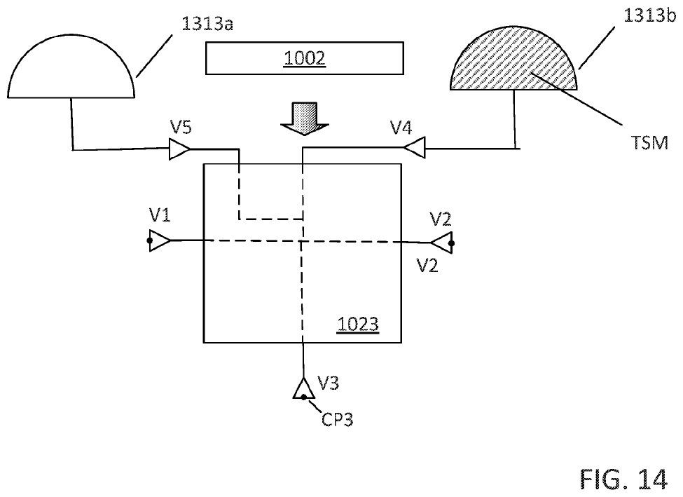

FIG. 14 is a schematic representation of a system that is similar to the system in FIG. 13, except there are no ships connected to the heat exchanger 1023 in FIG. 14 and there are multiple (two in the illustrated implementation) storage containers 1313a, 1313b co-located with (e.g., on the same platform as) the heat exchanger 1023. In the illustrated example, storage container 1313a is empty and storage container 1313b is full of liquid TSM. Both of these storage containers 1313a, 1313b are connected to the heat exchanger 1023 via fluid communication channels. More specifically, storage container 1313a is connected to the heat exchanger 1023 via a fluid communication channel that includes a valve V5 that can control fluid flow through the fluid communication channel. Storage container 1313b is connected to heat exchanger 1023 via a fluid communication channel that includes a valve V4 that can control fluid flow through the fluid communication channel. The fluid communication channel from storage container 1313a is connected to the fluid communication channel from storage container 1313b through a fluid flow path that extends through the heat exchanger 1023.

In the illustrated implementation, if valves V4 and V5 are open, while the other valves V1, V2, and V3 are closed, the liquid TSM from storage container 1313b can be (and sometimes is) pumped (with a pump, not shown) through the heat exchanger, where it picks up heat, and to the storage container 1313a. Having two storage containers like the ones shown in the figure, enables substantially continuous heating of liquid TSM, even in situations when no ships (or other vessels) are attached to the connection points CP1, CP2, CP3 for the heat exchanger 1023. At a later time, when a vessel with an empty liquid TSM container (not shown) connects to any of valves V1, V2, or V3, the heated TSM in storage container 1313b can be (and sometimes is) transferred to the container on the vessel (not shown) via a fluid path created by opening valve V5 and whichever of the valves V2, V2, or V3 to which the vessel has established connection. Similarly, the now empty storage container 1313b can be (and sometimes is) refilled with unheated liquid TSM supplied from a container on a vessel (not shown) via a fluid path connection established by opening whichever valves V1, V2, or V3 that the vessel is connected to and valve V4.

FIG. 1 is a schematic representation of an exemplary energy transmission system 100 that does not need (or utilize) any submarine cables to transmit electrical energy from an offshore wind farm 102 (made up of one or more offshore wind turbines) to a shoreside electrical power grid 104. The ocean 106 and the ocean floor 108 is visible in the illustrated sketch. As shown, no electrically conductive cables extend along the ocean floor 108, or otherwise through the ocean 106, to connect the offshore wind farm 102 to the shoreside electrical power grid 104. The illustrated system 100 includes the offshore wind farm 102, a shoreside energy conversion station 110, the shoreside electrical grid 104 (which is connected to the shoreside energy conversion station 110), and one or more ships 112a, 112b (each carrying a TSM container 122) that travel back and forth between the offshore wind farm 102 and the shoreside energy conversion station 110. As discussed herein, the system 100 is generally configured to capture natural wind energy at the offshore wind farm and to transport at least some of that captured energy to the shoreside electrical power grid for use by one or more electrical power grid customers and/or end users (e.g., homes, businesses, etc.). The natural wind energy, which is captured by the offshore wind turbine(s) of the offshore wind farm, goes through a series of conversions (e.g., mechanical to electrical, electrical to thermal, thermal to mechanical, mechanical to electrical) along the way. One or more ships are configured to receive the energy from the offshore wind farm, store the energy (in the form of heat in the TSM stored in container(s) onboard the ship(s)), and transport the energy from the offshore wind farm to a shoreside discharge at the shoreside energy conversion station 110.

In essence, the shoreside energy conversion station 110 is configured to convert thermal energy from the onboard TSM into electrical energy for the shoreside electrical power grid 104. This can, of course, be accomplished in a number of different possible ways. FIG. 1 shows one exemplary implementation of a shoreside energy conversion station 110 that can accomplish this conversion. The exemplary shoreside energy conversion station 110 illustrated schematically in FIG. 1 has a water delivery channel 124 that can attach to a water inlet on the TSM container 122 and a steam channel 126 that can connect to a steam outlet on the TSM container 122. Fluid flow through the water inlet channel 124 and the steam outlet channel 126 is controlled, in the illustrated implementation, by valves. More specifically, a water valve 128 is provided in the water delivery channel 124 to control water flow therein, and a steam valve 130 is provided to control.

The shoreside energy conversion station 110 also has a steam turbine 132, an electrical generator 134 connected (e.g., via a shaft) to the steam turbine 132, an electrical substation 136, a steam condenser 138, and a water feed pump 140. Other (or different) system components, including those that may normally be included in a steam-water cycle style system may be present as well.

During operation, the shoreside energy conversion station 110 delivers water 124 into the TSM container 122 via the water delivery channel 124 and the water inlet on the TSM container 122. The water absorbs energy from the TSM 120 inside the TSM container 122 and flashes into steam. The steam exits the TSM container 122 via the steam outlet and enters the steam channel 126. The steam channel carries the steam to the steam turbine 132. In an exemplary implementation, the steam turbine extracts thermal energy from the pressurized steam to drive the electrical generator 134 (via a shaft connection between the two). After passing through the steam turbine, the steam passes into the condenser 138. In a typical implementation, the condenser 138 uses a cooling medium (e.g., cool water) to cool the steam and cause it to condense back into water. The feed pump 140 pumps the condensed water from the condenser back into the TSM container 122. The electrical generator 134 in the illustrated implementation produces electricity, which is fed into the electrical substation 136 and then into the onshore electrical grid 104.

The offshore wind farm 102, in the illustrated implementation has an offshore wind turbine generator configured to harvest wind energy to generate electricity. The offshore wind turbine generator can be located in a body of water (e.g., an ocean, a lake, a fjord, etc.) where average wind speeds tend to be higher than available on land. The turbine generator may have any kind of configuration (e.g., fixed-foundation or floating) appropriate for the application.

In some implementations, the wind turbine generator(s) may be configured to generate electricity at a medium voltage level (e.g., 33 kV, 64 kV, or thereabouts or above). In implementations that include multiple generators, the multiple generators may be connected together, electrically, at a single medium-voltage electrical node. In such implementations, the single medium-voltage electrical node may be connected to an electrical power connector 114 (e.g., a plug or outlet) which is shown in FIG. 1 as being connected to a corresponding electrical power connector 116 on a ship 112a, 112b. In a typical implementation, electricity may be transferred from the offshore wind farm 102 to the ship 112a, 112b, via these mating electrical connectors 114/116 at whatever voltage level the offshore wind farm generates electricity. Thus, in a typical implementation, electricity can be transferred off of the offshore wind farm at a lower voltage level than might otherwise be advisable or practical for long distance transmission without having to step up or convert the voltage to a higher level for transmission.

Onboard the ship 112a, 112b, the electricity transferred from the offshore wind farm 102 is converted into thermal energy and stored in thermal storage material (TSM) 120 onboard the ship 112a, 112b. There are a number of ways in which this energy conversion (electrical to thermal) step may be performed. In the implementation represented in FIG. 1, for example, the electricity is passed through one or more electrical resistance heaters embedded in (or otherwise thermally coupled to) TSM 120 onboard the ship 112a, 112b. As electricity passes through the electrical resistance heater(s), the heater(s) heat up and that heat is released into the TSM 120.

The TSM 120 can be any one of a variety of different candidate materials. In an exemplary implementation, the TSM 120 takes the form of rock material (e.g., pebbles) stored in one or more TSM containers 122 onboard the ship 112a, 112b. Generally speaking, pebble-bed storage uses the heat capacity of a bed of loosely packed particulate material to store energy. A fluid (e.g., air) may be circulated through the bed inside the container 122 to facilitate adding (or removing) energy to (from) the TSM 120. The air, in those instances, may blow over the electrical resistance heaters, for example.

The TSM 120 can be a salt (e.g., a molten salt technology). In such implementations, sensible heat of the molten salt can be used for storing energy at a high temperature. In other words, in such implementations, molten salts can be employed as a thermal storage material to retain thermal energy. Various eutectic mixtures of different salts, for example, may be utilized as the TSM 120 (e.g., sodium nitrate, potassium nitrate and calcium nitrate). In one exemplary implementation, the salt may melt at about 131° C. (268° F.). The electrical resistance heater(s) may be immersed in, or otherwise nearby and thermally coupled to, the salt.

The TSM 120 can be an oil or wax (e.g., paraffin wax or petroleum wax, which is a soft, typically colorless, solid derived from petroleum, coal, or shale oil that consists of a mixture of hydrocarbon molecules). The electrical resistance heater(s) may be immersed in, or otherwise nearby and thermally coupled to, the oil or wax.

The TSM 120 can be concrete. Concrete has a lower thermal capacity than water, but concrete can be heated to much higher temperatures, e.g., by electrical heating and therefore provide a higher overall volumetric capacity. The electrical resistance heater(s) may be embedded in, or otherwise nearby and thermally coupled to, the concrete.

In the illustrated implementation, the TSM 120 is located in a container 122 (or tank) atop the main deck of the ship. However, in other implementations, the TSM 120 may be located in a tank below deck (e.g., in one of the holds of the ship). In a typical implementation, the tank is thermally insulated so as to resist/reduce undesirable thermal energy loss through the walls of the tank. The degree of insulation may depend, for example, on the type of TSM 120, the amount of energy to be carried in the TSM 120, as well as the size, shape, material and/or other characteristics of the TSM container 122, etc. A variety of different materials (including, e.g., polyurethane, etc.) may be used to thermally insulate the tank 122 containing the TSM 120.

FIG. 1 shows one of the ships 112b adjacent to the offshore wind farm 102 and connected electrically to the offshore wind farm 102 to receive electricity therefrom. In a typical implementation, the ship 112b may be tethered to (and/or anchored) nearby to one of the structures of the offshore wind farm 102, or to a permanent ship mooring system near the wind farm 102, the entire time that electricity is being transferred from the offshore wind farm 102 to the ship 112b. In a typical implementation, the duration of this transfer may depend, at least in part, on the thermal capacity of the TSM 120 onboard the ship, the amount of energy generated by the wind farm 102 while the vessel is being charged, and other factors. Moreover, in a typical implementation, once the transfer has been completed, the electrical power connector 116 of the ship 112b is disconnected from the electrical power connector 114 of the offshore wind farm 102 and the ship 12b is then free to sail back to shore, which it does.

Once the TSM 120 on the ship 112b has been charged with thermal energy, the ship 112b travels to a shoreside location (e.g., at the shoreline as shown in FIG. 1) where the thermal energy is converted back to electrical energy. FIG. 1 shows a ship 112a with a charged TSM store on its main deck docked at a harbor location (e.g., adjacent a dock).

In various implementations, water or low temperature steam is provided from a shoreside water or steam source (H₂O in FIG. 1), passed through a valved pipe 124 to the TSM container 122 onboard the ship 112a, and passed through one or more channels within the TSM container 122, picking up heat from the TSM 120, which turns the water into steam or turns the low temperature steam into superheated steam. The steam exits the TSM container 122 via a steam line 126 and enters a steam turbine 132 of a turbine-generator set. The steam causes the turbine to spin, which drives the electrical generator 134. The electrical generator produces electricity, which is fed, via an electrical conductor, to an electrical substation 136. The electrical substation 136 may include circuit breakers, transformers, controls, etc. to feed the electricity from the electrical generator 134 into an electrical grid 104 configured to deliver the generated electricity to a variety of consumers.

The electrical grid 104 in the illustrated implementation is an interconnected network for delivering electricity from electricity producers to electricity consumers. In a typical implementation, an electrical grid includes one or more generating stations that produce electric power for the grid, electrical substations that step electrical voltage up for transmission or down for distribution, high voltage transmission lines that carry electrical power long distances, and distribution lines and circuits that connect the individual electricity consumers to the grid. Electrical grids vary in size from relatively small grids (e.g., for a single building) to larger grids that might extend across an entire country or continent.

After passing through the shoreside turbine 132, the steam enters either the steam condenser 138 (to cool and condense the steam) or is put to some other use, e.g., to provide heat, for example in connection with an industrial process or for space heating.

In a typical implementation, the ship 112a generally remains docked or anchored shoreside and connected to the shoreside energy conversion system 110 until all or substantially all of the available thermal energy has been removed from the TSM. Once this happens, the ship 112a can get disconnected from the shoreside energy conversion system 110 (e.g., by disconnecting the water and steam channels 124, 126 from the TSM container 122 and otherwise untie from its dock) and sail back out to the offshore wind farm 102.

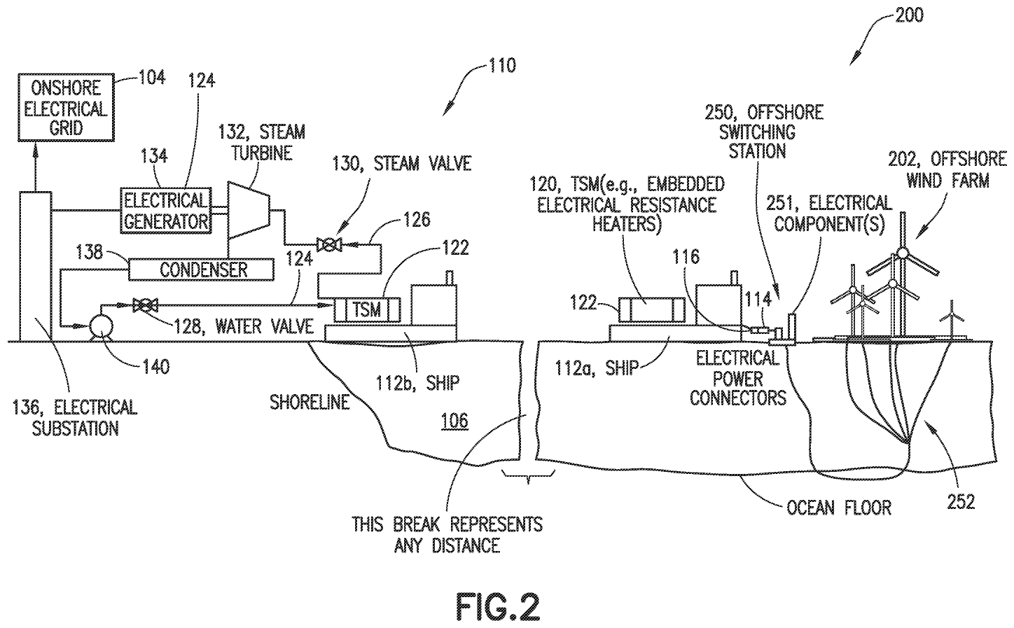

FIG. 2 is a schematic representation of an exemplary energy transmission system that is similar in many ways to the system in FIG. 1. The system in FIG. 2, however, has multiple offshore wind turbine generators that collectively form the wind farm 202, and a single offshore switching station 250 where the electrical outputs of all the offshore wind turbine generators are connected together (e.g., with electrical switchgear components 251 or the like). The offshore switching station 250 in the illustrated system has its own platform, separate from the other platforms in the wind farm. However, in some implementations, the offshore switching station 250 may be located on the platform of any one of the turbine generators in the wind farm 202 or may be distributed across multiple platforms. In various implementations, the offshore switching station 250 may have various provisions (e.g., buses, switchgear, etc.) for combining and/or converting the electrical outputs from the various wind turbine generators into a one or more outputs that can be connected to a corresponding electrical connector (e.g., to a ship or barge that has one or more containers of TSM thereon).

The TSM 120 (in FIG. 2 and/or in any other system) may be heated by an electrical resistance heater, or by means other than electrical resistance heaters. For example, in some implementations, a system may be configured to charge (or heat) a solid TSM using a fluid intermediary heat transfer fluid (HTF) (e.g., a fluid HTF such as water, or a gas HTF such as air) that circulates between a heater (that may be, e.g., on an offshore platform, or in the foundation of a turbine) that heats the fluid intermediary and the solid TSM (that may be in a container onboard a floating vessel, such as a ship or barge).

The HTF intermediary can be any one of a variety of different fluids. In various implementations, the fluid intermediary is (or includes) water. In some implementations, the fluid intermediary is (or includes) a suspension or solution of Magnesium Oxide or Magnesia Carbon. The purpose of these materials is to provide for thermal characteristics (e.g., boiling point) that improve the performance of the fluid when used as an HTF.

Thus, instead of using electrical resistance heaters a fluid HTF is instead circulated through the bed of solid storage material. Furthermore, in those implementations where the fluid HTF is heated in the foundation of the turbine, energy from the turbine is conveyed to the TSM by means of circulating the HTF, as opposed to an electrical connection. In some configurations a liquid TSM is utilized, and the liquid TSM is itself heated in the foundation of the turbine, and then conveyed to a storage container not on the foundation of the turbine, and in these configurations no HTF is required.

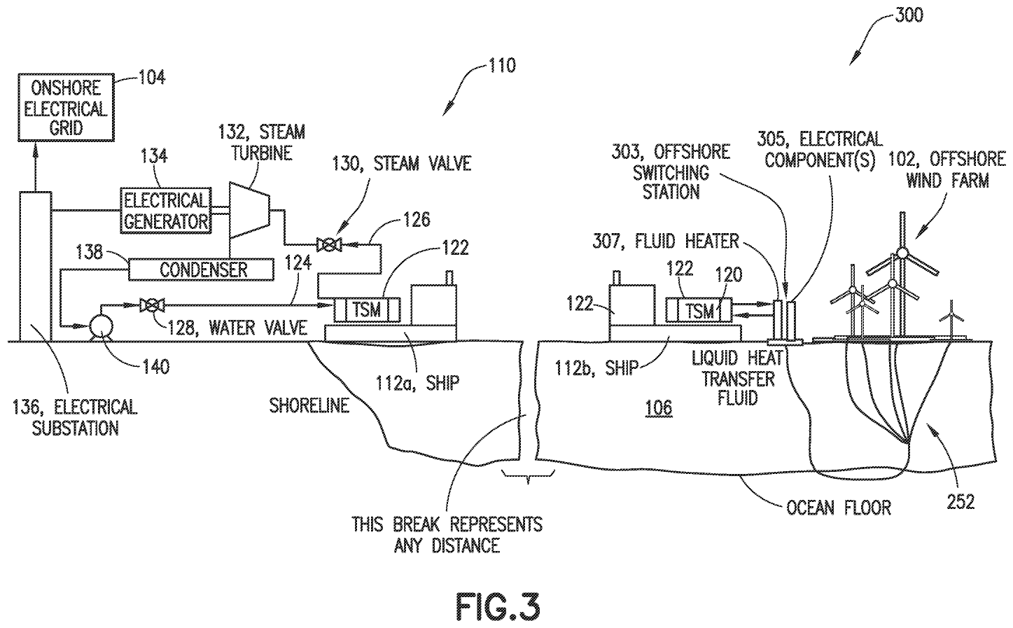

FIG. 3 is a schematic representation of an exemplary energy transmission system that utilizes a fluid HTF in the foregoing manner as a fluid intermediary to heat TSM 120 onboard a ship 112b. Aside from this difference, the system 300 in FIG. 3 is quite similar to the system 200 in FIG. 2.

In the FIG. 3 implementation, the offshore switching station 303 has electrical equipment 305 (e.g., buses, switchgear, etc.) configured to receive and consolidate the electrical outputs from the various offshore wind turbines in the offshore wind farm 102, and a fluid heater 307 that converts the energy of the consolidated electricity into a thermal energy in a fluid. In implementations that include an offshore wind farm 102 with only one offshore wind turbine, there would be no consolidation needed, and fluid heater might be located in the foundation of the turbine. The transfer of energy from the electricity to the fluid may be done in a number of ways. In one example, the fluid heater 307 may include internal electrical resistance heaters thermally coupled to internal fluid channels. The internal electrical resistance heaters would be electrically connected to receive the electricity produced by the offshore wind farm 102 (via the electrical equipment on the offshore switching station 303. The fluid heater 307 in the illustrated implementation has a fluid inlet and a fluid outlet that are connected to corresponding fluid connections at the TSM container 122 onboard the ship 112b that is at the offshore wind farm 102. In a typical implementation, a fluid pump (not shown in FIG. 3) would be provided to facilitate fluid flow between the fluid heater 307 and the TSM container 122.

During operation, fluid would circulate, under the influence of the fluid pump between the fluid heater 307 and the TSM container 122 onboard the ship. Electricity from the wind turbine(s) of the offshore wind farm 102 would be utilized to heat the fluid in the fluid heater 307. The heated fluid would be used to heat the TSM 120 inside the TSM container 122. Once the TSM reaches a target temperature (as measured by a temperature sensor, e.g., inside or on the TSM container 122, or otherwise thermally coupled to the TSM 120), the heating process may be suspended (e.g., by turning off the fluid pump, which may be done automatically by a controller in response to a signal from the temperature sensor), the fluid connections between the TSM container 122 and the fluid heater 307 could be disconnected (e.g., by a human physically closing one or more valves and then disconnecting the fluid connections), and the ship (with heated TSM 120) could be sailed back to shore.

It is important that the TSM container 122 be appropriately insulated. This is especially important if the distance between the offshore wind farm 102 and the shoreside energy conversion system 110 is large. Appropriate insulation helps minimize energy loss, and increase efficiency, while the energy is being transferred from the offshore wind farm 102 to the shoreside energy conversion system 110. To address this issue, in some implementations, the TSM container 122 is configured to hold or store the TSM 120 in such a manner that a vacuum or partial vacuum can be (and is) created between the TSM 120 and the external environment (outside the TSM container 122), thereby thermally insulating the TSM material and allowing the TSM to store energy for longer periods. A true vacuum would have absolutely no air or anything at all in the cavity between the TSM and the wall of the container holding the TSM, and this is difficult if not impossible to achieve as a practical matter. Therefore, any reduction in the amount of air (for example) in the cavity would improve insulation by having less mass in the cavity for conductive heat transfer. In other words, any amount of air LESS than what would be there under conditions would create a partial vacuum and have benefit. Exactly how “partial” the vacuum might be is dependent on a large number of factors. However, in a various implementations, the aim would be to produce a vacuum of at least 18″ of Hg, or at least 20″ of Hg, or at least 22″ of Hg, or at least 24″ of Hg, or at least 26″ of Hg, or more.

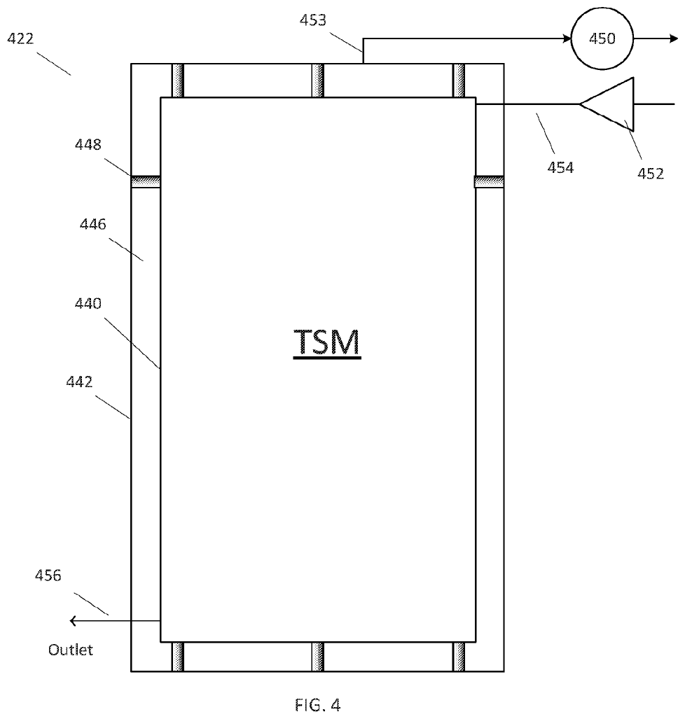

In the case of a fluid TSM, this might entail providing the TSM container as a double-walled tank, with all or some of the air having been evacuated from between the two walls that define a space therebetween that serves as a space that is under vacuum or partial vacuum. An example of this is shown in FIG. 4, which is a schematic cross-sectional view showing an exemplary double-walled TSM container 422.

The double-walled TSM container 422 in the illustrated implementation has an inner wall 440 and an outer wall 442 that surrounds and is physically displaced from the inner wall 440. The physical displacement of the outer wall 442 from the inner wall 440 provides a space 446 between the walls that serves as a thermally insulating space.

In a typical implementation, the TSM (either liquid or solid) is stored in an inner tank of the container 422 (i.e., inside the inner wall 440). There is no TSM in the space 446 between the inner wall 440 and the outer wall 442. In the illustrated implementation, there are braces 448 between, and in contact with, the inner wall 440 and the outer wall 442. These braces 448 help maintain a uniform space 446 between walls 440 and 442. Otherwise, the inner container (defined by inner wall 440) might be free to move around within the outer wall 442. Additionally, the braces 448 may provide support to resist deformation of either wall (primarily the outer wall 442) in response to the pressure differences manifested by the substantial vacuum in space 446.

The illustrated implementation shows a vacuum source 450 in fluid communication with the space 446 between the inner wall 440 and the outer wall 442 (via vacuum line 453). The vacuum source 450 can be virtually any kind of machinery (e.g., an air ejector or the like) that is able to create a low pressure (or vacuum) condition in the space 446. The illustrated vacuum source 450 is configured to draw vacuum in the space 446 through a fluid communication channel (e.g., pipe or tube).

Fluid (e.g., heated fluid) is delivered to the inner tank of illustrated double-walled container 422 through a fluid inlet line 454 (that has a fluid inlet valve 452). In a typical implementation, heat from the fluid passes into the TSM as the fluid travels through the inner tank. Then, after giving up a significant amount of heat to the TSM, cooled fluid exits the inner tank through a fluid outlet line 456, which also may have a valve (not shown in FIG. 4). The fluid inlet line 454 and the fluid outlet line 456 in the illustrated implementation both extend through the evacuated space 446 between the inner and outer walls of the container.

In some implementations, the inner tank in the illustrated implementation contains a solid TSM (e.g., in a rock-like form) and the heated fluid simply flows over the solid TSM (e.g., through crevices and/or other interstices defined therein) transferring heat into the solid TSM as it flows over the TSM.

In some implementations, the inner tank defines two or more internal fluid compartments or passages that respectively accommodate the heated fluid (e.g., heated by the electrical energy from the offshore wind turbine generators) and a liquid form of TSM. In some such implementations, the inner tank of the double-walled container 422 might contain one or more internal pipes that carry one of those fluids (i.e., the heated fluid or the liquid TSM) and define a space around the internal pipes to accommodate the other fluid. In those implementations, heat from the warmer of the two fluids would pass through the wall(s) of the pipe(s) to the cooler of the two fluids. In other implementations, the inner tank may include an arrangement of plates that define fluid flow paths on opposite sides thereof. In those implementations, the heated fluid (e.g., heated by the electrical energy from the offshore wind turbine generators) may flow on one side of each plate and the TSM liquid may flow on the opposite side of each plate. In such implementations, heat from the warmer of the two fluids flows through each plate to the cooler of the two plates. Other configurations are possible to facilitate heat transfer in the inner tank from the heated fluid (heated by electrical energy from the offshore wind turbine generators) to the TSM fluid.

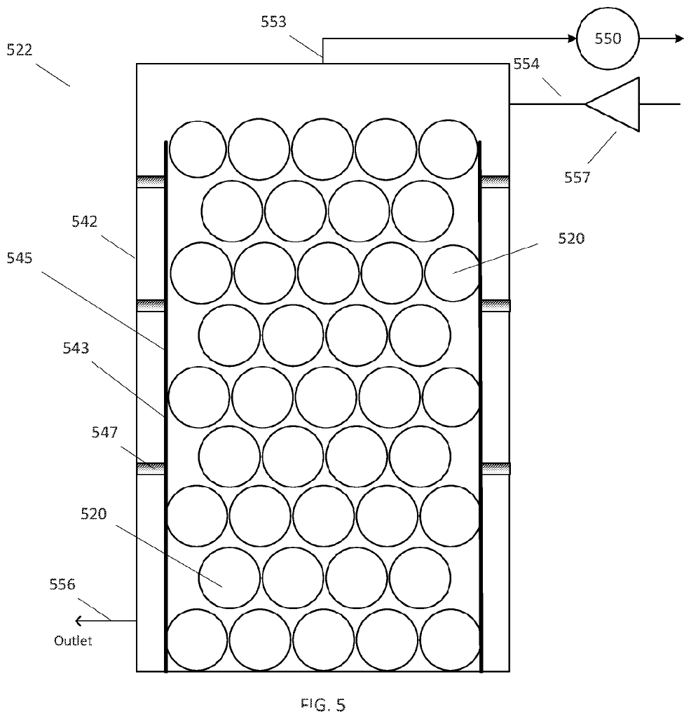

In some implementations, the TSM is solid and is positioned the inner compartment (in FIG. 4) in such a manner that there is a gap between some or most of the TSM and the wall 440 of the inner compartment (e.g., by using racks or similar structures to hold the solid TSM material securely away from the wall). Alternatively, the TSM container could be configured as a single-wall container that contains solid TSM. An example of this is shown in FIG. 5, which is a schematic, cross-sectional side view of a TSM container 522.

The illustrated TSM container 522 has a single outer wall 542. There is a rack 543 inside the TSM container that has a frame element 545 (that may be a solid cylindrical wall, screen, fence, or the like) and brace elements 547 that extend in an outward direction from the frame element 545 to contact an inner surface of the outer wall 542. Solid TSM 520 is inside the TSM container 522 and inside the frame element 545. The frame element 545 surrounds the TSM 520 on all sides and, in the illustrated implementation, the frame element 545 and the brace elements 547 cooperate to hold the solid TSM 520 in place displaced a distance from an inner surface of the outer wall 542 of the TSM container 522.

The solid TSM 520 in the illustrated implementation is in direct physical contact with a bottom surface of the TSM container 522. However, in some implementations, the rack 543 may have a bottom surface that extends below and supports the solid TSM 520 above the bottom surface of the TSM container 522.

The illustrated implementation includes a vacuum source 550 (e.g., a vacuum pump, air ejector or the like) that is in fluid communication (via vacuum line 553) with the interior of the TSM container 522.

The illustrated implementation includes a fluid inlet line 554 and a fluid outlet line 556 that are in fluid communication with the interior of the TSM container 522. There is a valve 557 shown in the fluid inlet line 554. In a typical implementation, the fluid inlet line delivers heated fluid (heated with electrical energy from the wind turbine generators) to the interior of the TSM container 522, where it can flow through (and physically contact) the solid TSM 520 contained therein, giving of heat/energy to the TSM 520 in the process. The cooled fluid exits the TSM container 522 via the fluid outlet line 456 after giving off its heat to the solid TSM inside the TSM container 522. The fluid outlet line 456 may have a valve (not shown in FIG. 5) as well.

The vacuum source 550 is operable to evacuate air from the interior of the TSM container 522. In a typical implementation, the inside of the entire compartment is evacuated (by the vacuum source 550) so that there is little, if any, thermal bridging between the TSM material and the compartment wall. In the case where the entire compartment is evacuated, the evacuation could occur after the thermal charging is complete (i.e., after heat has been transferred into the solid TSM (e.g., by heated fluid flowing over the TSM or otherwise)). In such implementations, the vacuum (or low pressure) may not need to be maintained in the container during the thermal charging process. Only after the thermal changing has been completed would the container then be evacuated. In some implementations, the illustrated configuration could be integrated, for example, into the storage holds of oceangoing vessels, for the purpose of transporting heat energy from offshore wind turbines to shore.

The vacuum source 550 in the illustrated implementation is in fluid communication with the space inside the single outer wall 542. The vacuum source 550 can be virtually any kind of machinery (e.g., an air ejector or the like) that is able to create a low pressure (or vacuum) condition in the space. The illustrated vacuum source 550 is configured to draw vacuum in the space through a fluid communication channel (e.g., pipe or tube).

In some implementations, a thermal energy storage system may utilize Magnesium Oxide, MgO, or Magnesia Carbon, MgO—C, as a thermal energy storage material (or as part of a combination of materials). Such thermal energy storage systems may be similar to the TSM containers described elsewhere herein. Alternatively, the thermal energy storage systems can be virtually any type of system in which storage of thermal energy (e.g., in a solid material) is desired, especially in systems, such as those described herein, where the thermal energy is intended to be later released and put to use in some constructive manner (e.g., to generate electricity for an electrical grid).

In various implementations of systems (such as those shown in FIGS. 1-3), multiple floating vessels (e.g., ships 112a, 112b) may be used to service a single offshore wind turbine generator 102 (or group of offshore wind turbine generators 102) with a single set of electrical connection (e.g., 114) to ensure continuous (or nearly continuous) energy transfer from the offshore wind turbine generator(s) (and storage) in TSM onboard the floating vessels (e.g., whenever the turbine generator(s) is (are) generating electricity): In such systems, the multiple vessels can move in and out of engagement in a manner that enables the transfer of energy to the TSM on each respective vessels, sequentially.

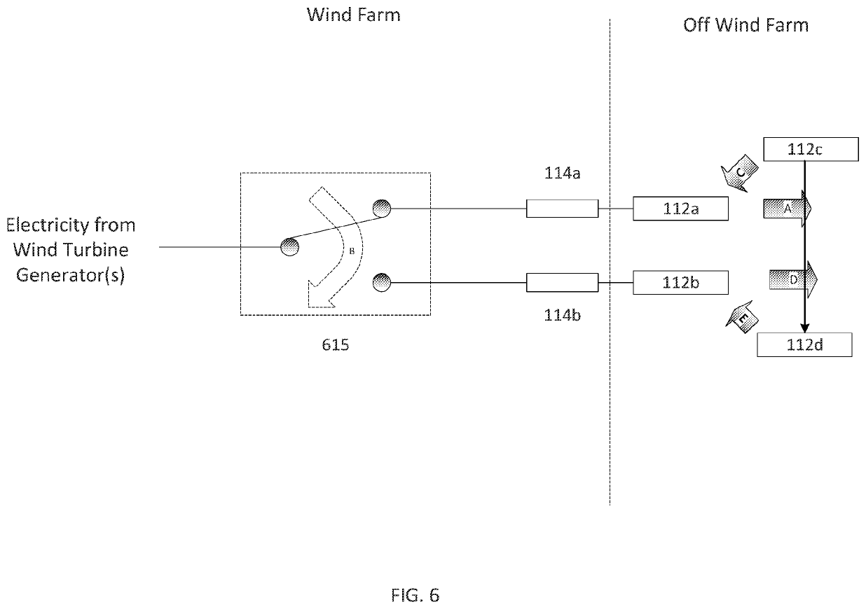

An example of this kind of system/approach is shown in FIG. 6. In the illustrated implementation, the system has multiple electrical power connectors (114a, 114b) for the offshore wind turbine generator(s) of an offshore wind farm and a switch 615 that switches between the power connectors 114a, 114b. In such implementations, for example, when the switch is in a first position (up, as shown), electricity from the offshore wind turbine generator(s) can be directed through the switch 615 to a first one of the electrical power connectors 114a (but not the other power connector 114b), whereas when the switch 615 is in a second position (down, not as shown), electricity from the offshore wind turbine generator(s) can be directed through the switch 615 to a second one of the electrical power connector(s) 114b (but not the first power connector 114a). The switch 615 can be operable manually or automatically. In implementations where the switch 615 is switched automatically, the system may include one or more temperature sensors, timers, etc. that sense temperature or keep track of how long (e.g., in seconds) a particular power connector has been receiving (and transmitting) electrical energy. In such implementations, if a temperature sensor, for example (at one of the TSM containers onboard a vessel), provides a signal (e.g., to a controller) indicating that the TSM has been fully charged, then the controller may compare this signal to a set point for temperature (saved in memory) and cause the switch 615 to automatically flip positions. Similarly, in implementations where a timer may be used, the system may operate in a similar manner, but in response to a certain time period elapsing (e.g., if electricity has been delivered via one route for x number of minutes, the flip happens).

In such implementations, a first vessel 112a pulls up and gets connected (as shown) to the first connector 114a and electricity from the offshore wind turbine generator(s) is directed through the switch 615 to the first vessel 112a, where the associated energy is stored (e.g., in the form of heat in TSM onboard the first vessel 112a). A second vessel 112b can pull up and connect to the second connector 114b (as shown in FIG. 6). This can be done before, during or after the charging of the first vessel 112a. If done while the first vessel is being charged, then the second vessel typically stands by waiting for the first vessel 112a to be done charging.

When the first vessel 112a is done charging, the first vessel 112a can disconnect from the first connector 114a and start sailing back to shore (see arrow A), carrying with it energy, typically in the form of heat, from the offshore wind farm to shore. The switch 615 then changes position (either automatically or manually) from the up-position (as shown in FIG. 6) to a down position (see curved arrow B). When the switch is in the down position, electricity from the wind turbine generator(s) can be directed through the switch 615 to the second vessel 112b via second connector 114b. The associated energy is stored (e.g., in the form of heat) in the TSM onboard the second vessel 112b.

Meanwhile, after the first vessel 112a disconnects from the first electrical connector 114a and starts to sail away, a third vessel 112c can pull up and get connected to the first connector 114a (see arrow C) in the spot that the first vessel 112a just vacated. This can be done, for example, while the second vessel 112b is connected to the second electrical connector 114b and being charged. This way, the third vessel 112c will be ready to start charging as soon as the second vessel 112b is done charging.

Then, when the second vessel 112b is done charging, the second vessel 112b can disconnect from the second connector 114b and start sailing back to shore (see arrow D), carrying with it energy, typically in the form of heat stored in TSM, from the offshore wind farm to shore. The switch 615 then changes position (either automatically or manually) from the down-position to the up position (opposite the direction of the curved arrow B). When the switch 615 is in the up position, electricity from the wind turbine generator(s) can be directed through the switch 615 to the third vessel 112c via the first connector 114a. The associated energy is stored (e.g., in the form of heat in TSM) onboard the third vessel 112c.

Meanwhile, after the second vessel 112b disconnects from the second electrical connector 114a and starts to sail away, a fourth vessel 112d can pull up and get connected to the second connector 114b (see arrow E) in the spot that the second vessel 112a just vacated. This can be done, for example, while the third vessel 112c is connected to the first electrical connector 114a and being charged. This way, the fourth vessel 112d will be ready to start charging as soon as the third vessel 112c is done charging.

In a typical implementation, this sequential rotation of vessels in and out of engagement with the offshore wind farm electrical connection(s) can continue with as many vessels are needed to facilitate constant (or nearly constant, e.g., 90% or more of the time) capacity to transfer energy through the electrical connection(s) for thermal storage and transport ashore. In general, more vessels provide for greater continuity of energy transfer. Typically, each vessel would dock or moor around the turbine structure to receive energy from the turbine, and then once charged travel back to an on-shore or near-shore energy discharge station.

This general approach may vary, for example, depending on the type of TSM being used.

In some implementations, for example, the system may use a solid TSM onboard the vessels. The TSM could be heated utilizing an onboard heating mechanism, as described above, and an electrical connection between the turbine and the vessels can be used to transfer energy from the turbine to the vessel, where it is converted to thermal energy for storage. Once all the TSM on-board is fully charged, the electric power is instantly switched to another vessel that has already established a connection to the turbine.

In other implementations, the vessel may use a solid TSM but charged with a fluid Heat Transfer Fluid (HTF) that is heated on the turbine platform (i.e., not on the vessel). In those implementations, a pipe or duct connection may be made between the turbine and the vessel, with the HTF circulated through the pipe(s) or duct(s). As one vessel is fully charged, the HTF may be immediately redirected through the piping system to another vessel waiting to be charged. The HTF could be any material including air, solar salt, etc.

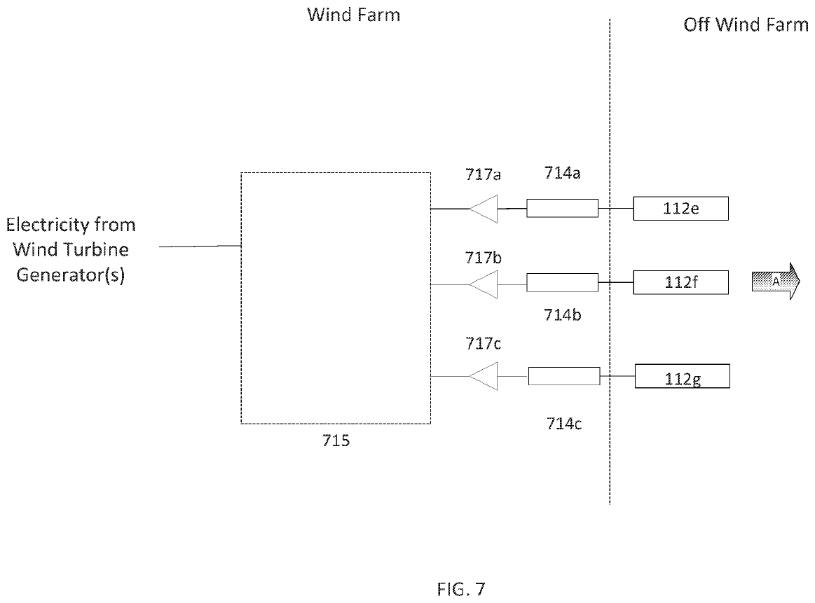

In other implementations, a liquid TSM material may be transferred between vessels at or near the offshore wind farm and heated along the way. In such implementations, the TSM may be moved between the vessels and a turbine platform, for example, so as to move energy from the turbine platform to the vessel (and therefore no separate HTF is used). An example of this kind of system is represented in the schematic representation of FIG. 7.

The system in FIG. 7 includes an offshore wind farm with one or more wind turbine generators and a platform that includes a heater 715 that can facilitate the transfer of energy from electricity generated by the offshore wind turbine generators to a liquid TSM passing through the heater. The system also has multiple vessels that can sail between the offshore wind farm and a shore side energy conversion system. Each vessel has a TSM container onboard with capacity to store liquid TSM in a thermally insulated manner to transport energy there between.

In the illustrated system, unheated liquid TSM is pumped from a first vessel 112e to a TSM heater 715 onboard a platform that is at or near (and forms part of) the offshore wind farm. The platform may be a floating platform and the liquid TSM may pass from the vessel to the platform/heater 715 via a first fluid connector 714a. Onboard the platform, the liquid TSM passes through a first valve 717a and into the heater 715. Inside the heater, electricity from the wind turbine generator(s) of the wind farm is used to heat the liquid TSM to a charge temperature. The first valve 717a, and any other valves, can be controlled manually or automatically to control flow. Essentially, the heater 715 is configured in this regard to transfer energy from the electricity to the liquid TSM. There are a variety of ways that this can be done including, for example, by using electrical resistance heaters or a heat pump to heat the TSM liquid, or a combination of both means.

Once heated, the liquid TSM exits the heater 715 and passes through a second valve 717b, not back to the first vessel 112e, but to a second vessel 112f that has available capacity to receive and store the charged (heated) TSM. The liquid TSM passes from the heater 715 platform to the second vessel 112f via a second fluid connection 714b. The first and second fluid connections can be virtually any kind of pipe or hose connection that is easy to connect or disconnect (e.g., by hand or with simple tools). In some implementations, the second vessel 112f will have been waiting with an empty TSM container for the load of charged (heated) TSM to be pumped onboard. The load of charged TSM is pumped into that empty TSM container.

Once loaded with the charged TSM, the second vessel 112f disconnects from the turbine and begins to sail ashore (see arrow A).

Next, unheated TSM is immediately drawn from a third vessel 112g that is already connected to the heater 715 (via fluid connector 714c and valve 717c) in readiness to immediately provide this unheated TSM. After the TSM from the third vessel 112g is heated by the heater 715 to charge temperature, it is pumped (via valve 717a and fluid connector 714a) to the first vessel 112e, which at that point will have a TSM container that was just emptied and, therefore, has storage capacity to receive the just-heated TSM. The load of charged TSM is pumped into that empty TSM container. Meanwhile while this process is underway, a fourth vessel 112h containing unheated TSM arrives at the turbine and connects to the fluid connector 714b and valve 717b, that is, at the connection point recently vacated by vessel 112f.

Once loaded with the charged TSM, the first vessel 112e disconnects from the turbine and begins to sail ashore. Unheated TSM from recently arrived vessel 112h is provided to the heater 715 via fluid connector 714b and valve 717c, the TSM fluid is heated by the heater, and then pumped into the now empty TSM container of vessel 112g.

This process continues as vessels in turn arrive and connect to the turbine, discharge unheated TSM, receive heated TSM, and then disconnect from turbine to deliver the heated TSM to shore.

In some implementations, a similar process may take place, but using only a single vessel (with multiple TSM container onboard) at a time. In those implementations, an ocean-going vessel may have built into it compartments of equal or similar size for storage of liquid TSM, and piping to transfer the TSM between compartments and/or between compartments and a heater (either off-vessel or on the vessel). In operation, one of the compartments is always empty (or having been empty is being filled), such that the TSM can be removed from a full compartment, heated to charge temperature (e.g., by an electric resistance heater, such as 715), and then piped or pumped to an empty or filling compartment. This would allow for more efficient heating of a liquid TSM that is carried on board a single vessel that will both provide unheated TSM and simultaneously receive heated TSM for the purpose of offshore thermal energy storage, as the heated and unheated TSM are always kept separate. In a typical implementation, the vessel is designed with appropriate ballasting mechanisms to safely accommodate any one of the TSM storage compartments being empty while underway.

For clarity, one would likely either use a system like the one in FIG. 7, or the single-vessel (multiple-compartment) system just described, but probably not both. The system of FIG. 7 has an advantage of making full use of TSM storage capacity of any single vessel, but requires multiple vessels to service off-shore wind turbine generator or farm on an on-going basis, whereas the single vessel (multiple-compartment) system generally only uses about half of the total TSM storage capacity of any given vessel, but has the advantage of requiring only one vessel at a turbine at any particular time in order to provide thermal energy storage and transportation service to an offshore wind turbine generator or farm. A possible scenario is that the FIG. 7 system is used on a routine basis, but the single vessel (multiple-compartment) system is used in an emergency basis when, for whatever reason, it is not possible to use the FIG. 7 system/approach, in which there are 2 or more vessels providing thermal energy storage and transport service to a particular turbine. In another implementation, a TSM storage tank or tanks may be incorporated into the turbine platform, allowing for the storage of heat energy should a vessel by unable to provide unheated TSM or receive heated TSM, for example because the vessel is unable to make the connection due to inclement weather, or to provide a buffer supply of TSM to allow for only two vessels to provide continuous service instead of three.

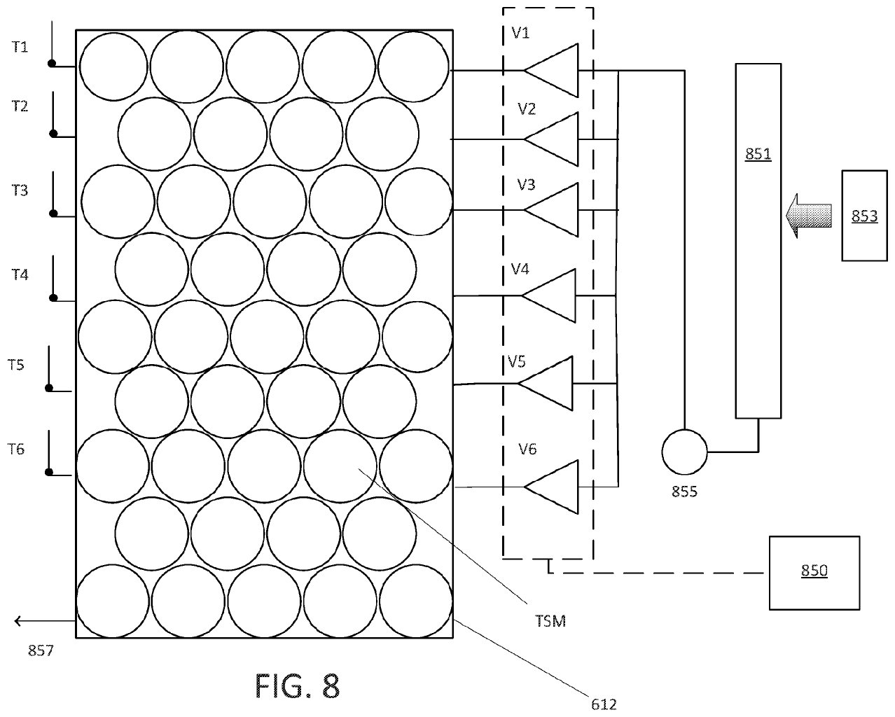

The TSM container may take on any one of a variety of other configurations. For example, FIG. 8 shows an implementation of a TSM container 612 that has an accumulation (or group) of solid TSM (e.g., containing magnesium) therein in a stacked or columnar arrangement, with interstices within and throughout the accumulation of TSM. More specifically, in the illustrated implementation, the TSM is composed of TSM in the form of spheres held in a tank (the spheres, in particular, are shown schematically in FIG. 8 and are not to scale) with gaps or spaces there between. Alternatively, the TSM might take the form of bricks or blocks with gaps or spaces to allow fluid to flow there between (e.g., between and around the stack of blocks). Of course, the individual pieces of TSM may take on any other shapes, regular or irregular and the shape of individual pieces may vary. A plurality of pipes (which, alternatively could be hoses, ducts, etc.) are configured to inject or introduce a fluid heat transfer fluid (HTF) through ports in a side wall of the container, at different levels of the TSM stack so as to efficiently charge the entire amount of solid TSM. More specifically, in the illustrated implementation, there are six pipes, each of which enters the TSM container at a different height from the base than the others. Each pipe has an associated valve (V1 to V6), and each valve (V1 to V6) is controlled by a controller 850. There is also a plurality of temperature sensors (T1 to T6) coupled to the TSM container. Each temperature sensor (T1 to T6) senses a temperature inside the TSM container at the height where that temperature sensor is located. The temperature sensors (T1 to T6) are configured to provide sensor signals (indicating the sensed temperatures) to the controller 850. The controller 850 is configured to control operation of the valves based on temperature signal(s) from one or more of the temperature sensor(s) (T1 to T6). More specifically, in a typical implementation, the controller 850 is configured to be able to open and close any one or more of the valves (V1 to V6) independently.

It is worth noting that although the illustrated TSM container configuration has the same number of temperature sensors as valves—six—, that need not be the case. In fact, in some implementations, the TSM container configuration may have as few as one temperature sensor, and as few as two valves. In some implementations, the number of temperature sensors can be higher than the number of valves, or vice versa.

The illustrated system also has an external tank 851 for storing fluid (e.g., the HTF) and a source of thermal energy 853. The source of thermal energy 853 can be virtually any source of thermal energy 853, including any of the thermal energy sources disclosed herein. Examples include a system comprising an electric generator, a geothermal system, and a solar-powered system. The thermal energy source 853, in the illustrated implementation, transfers heat into the fluid in tank 851 (e.g., utilizing an appropriate heat exchanger configuration, e.g., those disclosed herein) to produce heated fluid (e.g., HTF).

The system also has a pump 855 that is configured to pump fluid from the tank 851 to the TSM container 612 through whichever one (or more) of the valves V1-V6 may be open.

According to one exemplary implementation, at the start of a charging process, the HTF is introduced, under the pumping influence of pump 855, (via valve V1) near the top of the TSM stack and flows from the top of the stack down, contacting the solid TSM and thereby transferring heat to the TSM as the fluid HTM flows down through the interstices of the TSM stack by gravity. At that point in time, in this particular implementation, valve VI is in an open position, but all of the other valves are in a closed position.

Meanwhile, the temperature sensor(s) (T1 to T6) send temperature signals to the controller 850 indicating sensed temperature(s) within the TSM container. Temperature sensor T1, in this example, would be sensing the temperature at the highest sensing point in the TSM container. This would also likely be the highest sensed temperature in the TSM container since the heated fluid is entering the TSM container at the top of the TSM container and loses heat to the TSM as it flows down through the TSM container, and also because heat within the TSM container would tend to rise.

The fluid flows through the container 612 and over the TSM under the influence of gravity and exits the container 612 through an outlet 857 at or near the bottom of the container 612. The outlet 857 may return the fluid to its original tank 851 or to a different tank 851 or other destination.

As the very top portion of the solid TSM reaches a full charge temperature, the temperature signal from temperature sensor provides an indication of the temperature to the controller 815. The controller reacts to that indication by signaling to close valve V1 at the top of the TSM container and opening valve V2, which is the next valve to the TSM container below valve V1. In response, valve V1 closes and valve V2 opens. Thus, fluid HTF injection at the very top of the TSM stack is discontinued and the HTF is then introduced at the next lower HTF pipe level. Once that second level of TSM is fully heated, HTF injection at that level is stopped and injection begins at the next level down from the second, and so on. This process continues until the very lowest level of HTF injection pipe is used (corresponding to valve V6) and once that level is sufficiently heated (as indicated by the temperature signal from temperature sensor T6), the entire TSM stack will have been fully heated from top to bottom. The controller 850 will then close valve V6, at which point, all valves will be closed and charging of the TSM container will be considered complete.

In a typical implementation, the controller 850 stores either preset or user adjustable set point temperature values for determining whether a particular level in the TSM container is fully charged. The controller 850, in those implementations, determines whether to switch between valves based on a determination that includes comparing the temperature sensor signals it receives to the set point temperature values stored (e.g., in memory).

This is an efficient means to heat a solid TSM using an HTF, because a) the HTF is for the most part circulated using gravity (unlike e.g., large fans that need to be used if the HTF is air or a gas) and b) the temperature gradient and therefore charging efficiency between TSM and HTF is optimized using the counter flow heat exchange principle. This system could be integrated into a ship, for the purpose of using thermal energy storage to transport energy from offshore wind turbines back to shore. Or it could be deployed on-shore using tall silos or stacks to efficiently store heat energy using a solid TSM and a fluid HTF.

Additionally, the heating system described by FIG. 8 and/or the use of magnesium (e.g., MgO) as a TSM could be used for energy storage generally, not just for the purpose of transporting energy. To be clear, these are separate ideas that could be used together or separately. So, for example, the heating system in FIG. 8 (or any other heating system disclosed herein) could be used for stationary energy storage without being physically transported from one location to another. Likewise, MgO can be used as a TSM in any kind of heating system or heat storage system, whether the MgO is transported or remains stationary. Thus, the MgO can be used as TSM in the heating system in FIG. 8 (or in any other heating system or heat storage system disclosed herein or in any other kind of heating system or heat storage system) whether the MgO is transported or remains stationary.

The system in FIG. 8 could also be used in reverse (e.g., to draw thermal out of heated TSM inside the container 612). In this regard, an unheated fluid may be introduced (e.g., under the influence of a pump) into the container 612 via a first one of the plurality of fluid communication ports (e.g., through 857 in FIG. 8) at a first height either through or above the bottom surface of the container. The unheated fluid thus introduced into the container 612 flows from the first height up through the interstices in the TSM by means of pumping or pressurizing the fluid (with a pump, not shown), while being heated by the heated TSM that the fluid flows past and is removed from the container 612 via a second one of the plurality of fluid communication port (e.g., through open valve V6) that is located above the first one of the plurality of fluid communication ports (at 857).

Subsequently, (e.g., in response to a temperature threshold being met in the container 612) valve V6 closes and valve V5 opens. This suspends the removal of fluid from the container 612 through the fluid communication port connected to the valve V6 and begins removal of fluid from the container 612 through the fluid communication portion connected to valve V5, which is higher than the fluid communication port for the V6 valve. The fluid that is removed from the container 612 via the V5 valve communication port will have flowed through the interstices in the TSM by means of pumping or pressurizing the fluid (e.g., with a pump, not shown) while being heated by the heated TSM that the fluid flows past. This process continues, with the valves opening one at a time, in reverse sequential order from V6 to V5 to V4 to V3 to V2 to V1. Each time there is a switch from one valve to the next higher valve, the switch happens automatically in response to a temperature threshold being met and in response to a signal from the controller 850 that recognizes the threshold being met based on temperature data provided by one or more of the temperature monitors T1-T6, which monitor temperatures at different heights within the container 612. Valve switching may occur automatically in response to a signal indicating that a particular one of the monitored temperatures has reached a predetermined value. The heated fluid (which may include magnesium) may be collected in container 851 and stored there until and unless it is moved or put to use in a practical application.

A number of embodiments of the invention have been described. Nevertheless, it will be understood that various modifications may be made without departing from the spirit and scope of the invention.

For example, the TSM may be provided in multiple different containers/tanks. The containers/tanks may be different sizes and configurations. Moreover, different types of TSM may be utilized, even on the same ship, or not on a ship at all or transported at all.

The shoreside energy conversion system can be configured in any one of a variety of different configurations and may utilize any of a variety of different energy conversion technologies. Moreover, in various implementations, aspects of the shoreside energy conversion system may be provided on the ship, instead of actually on shore. In those implementations, for example, the turbine generator may be provided onboard the ship and the resulting electricity generated by the turbine generator may be transferred shoreside via electrical connector into a corresponding shoreside electrical connector that feeds into the electrical substation. Or, heat energy may be transferred from the vessel to a stationary, onshore TSM system where the heat energy is stored until a later time (for example, when demand for electrical energy is greatest) at which later time it is then converted to electrical energy. Other configurations are possible as well.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are disclosed herein as occurring in a particular order, this should not be understood as requiring that such operations be performed in the particular order shown or in sequential order, or that all represented operations be performed, to achieve desirable results.

In certain implementations, the systems and techniques disclosed herein avoid all cables whatsoever from the wind farm to shore side, it is possible that a wind farm might want to use both a cable and the system(s) disclosed herein. For example, if a 1000 MW wind farm can only build a cable rated for 800 MW for technical or commercial reasons, they could use this ship system for the remaining 200 MW. In other words, an offshore wind farm could choose to use two different means of energy transmission at the same time.

The exemplary systems disclosed herein are described as having no electrical power cables extending along the ocean floor, or otherwise through the ocean, to connect the offshore wind farm to the shoreside electrical power grid. In some implementations, the system(s) and techniques disclosed herein may be utilized in systems that include one or more electrical power cables that extend, either along the ocean floor or otherwise through the ocean, to connect the offshore wind farm to the shoreside electrical power grid. In those implementations, any energy transported using the TSM on one or more vessels might supplement any energy transported via the one or more underwater power transmission cables.

The exemplary systems disclosed herein are described as being deployed in an ocean environment. However, in various implementations, these systems could be deployed in other environments, such as lakes or other large bodies of water. Moreover, in some implementations, the systems and techniques disclosed herein may be deployed in an entirely shoreside system (e.g., one without any water environment at all). In such implementations, for example, the vessels mentioned herein may be any kind of transport vehicle (e.g., a truck, rail car, or the like) hauling one or more TSM containers, instead of the ship or other ocean-going vessels/transport vehicle, hauling TSM container(s). Also, as noted before, the use of TSM with magnesium (e.g., MgO) and the system described in FIG. 8 could be used for stationary energy storage as well, without any transport of the TSM.

The shoreside energy conversion station disclosed herein (as shown in FIG. 1, for example) can vary considerably from the exemplary implementations shown and described herein. Essentially, the shoreside energy conversion station can be any kind of facility that is able to convert heat energy from a solid or liquid TSM onboard a ship to electrical energy for delivery into the electrical power grid.

Thermal energy can be added to and/or removed from the TSM (in solid, liquid, or gas form) in any manner whatsoever including, for example, by utilizing a fluid intermediary (e.g., water or other fluid, e.g., a suspension or solution of Magnesium Oxide or Magnesia Carbon, etc.) to add and/or remove the thermal energy. In those instances, the fluid intermediary may pass through a fluid communication channel (e.g., pipes or other passages) through or otherwise thermally coupled to the TSM (such that heat can readily pass between the TSM and the fluid intermediary). In some implementations, thermal energy may be delivered into the TSM at or near one location (e.g., an offshore wind farm) and removed from the TSM at near a second location (e.g., a shoreside station). In those implementations, fluid intermediary may be used at one or both locations to add thermal energy into or take thermal energy out of the TSM. In some implementations, thermal energy may be delivered into the TSM at one point in time and removed from the TSM at later point in time. In those implementations, fluid intermediary may be used at one or both times to add thermal energy into or take thermal energy out of the TSM.

In various implementations, the fluid intermediary may be or include any of various common fluids used in industrial processes for transferring heat, including, simply water. In some implementations, water used this way will be under pressure, to keep it from boiling. Another option is a salt solution of water, and the possible variations here are many, given the types of salts and concentrates typically used. There is a wide range of “off the shelf” salt solutions for these types of purpose offered by various companies. Some of them are designed for particular uses. For example, a couple companies offer “solar salt” solutions for use in solar thermal generators. Another class of water-based solutions are those of various chemicals, usually an alcohol or glycerin, that give the water better heat carrying properties and keep the water from boiling. These are sort of industrial versions of the fluid used in car radiators or home heating systems. Often all of these water based solutions also have chemicals added to help resist corrosion in the system or impart other favorable performance characteristics.

In addition to water based fluids, the fluid intermediary could be or include an oil based (“hydrophobic”) fluid. Typically, these are oils whose chemistry allow them to get to very high temperatures without burning or igniting. That being said, a drawback of oil based fluids is the potential for fire or hazardous fumes. Advantages include that the fluids usually are not as corrosive and have other properties (e.g., viscosity) that impart advantages in how they work within a system.

More recently, there have been developments using suspensions or solutions of molecules or particles that are engineered specifically for being heat transfer fluid. These may be useful as the fluid intermediary or a component thereof.

Moreover, in some implementations, a vacuum or low pressure is created to facilitate insulating a TSM container. In various implementations, the evacuation of air to create the vacuum environment may be accomplished before, during or after heating the TSM.

Unless otherwise indicated, the term fluid, as used herein may refer to a substance in the form of a liquid or a gas, for example.

Other implementations are within the scope of the claims.

1-6. (canceled)

7. A method comprising:
providing a container that contains an accumulation of solid thermal storage material (TSM) with interstices formed throughout the accumulation, and that has a plurality of fluid communication ports at different heights above a bottom surface of the container;
introducing a heated fluid into the container via a first one of the plurality of fluid communication ports at a first height above the bottom surface of the container, wherein the heated fluid introduced into the container flows from the first height down through the interstices while heating the TSM that the heated fluid flows past; and
subsequently discontinuing the introduction of the beated fluid into the container via the first one of the plurality of fluid communication ports and instead introducing the heated fluid into the container via a second one of the plurality of fluid communication ports at a second height above the bottom surface of the container,
wherein the second height is lower than the first height, and
wherein the heated fluid introduced into the container via the second fluid communication port flows through the interstices while heating the TSM that the heated fluid flows past.

8. The method of claim 7, further comprising:
monitoring one or more temperatures inside the container,
wherein discontinuing the introduction of the heated fluid into the container via the first one of the plurality of fluid communication ports and instead introducing the heated fluid into the container via a second one of the plurality of fluid communication ports occurs automatically in response to a signal indicating that a particular one of the monitored temperatures has reached a predetermined value.

9. The method of claim 7, further comprising:
heating the fluid to produce the heated fluid,
wherein heating the fluid to produce the heated fluid comprises transferring thermal energy from a source of thermal energy into the fluid.

10. The method of claim 9, wherein the source of thermal energy is a system selected from the group consisting of a system comprising an electric generator, a geothermal system, and a solar-powered system.

11. The method of claim 7, wherein the TSM comprises magnesium.

12. A method comprising:
providing a container that contains an accumulation of solid heated thermal storage material (TSM) with interstices formed throughout the accumulation, and that has a plurality of fluid communication ports at different heights relative to a bottom surface of the container;
introducing a fluid into the container via a first one of the plurality of fluid communication ports at a first height either through or above the bottom surface of the container,
wherein the unheated fluid introduced into the container flows from the first height up through the interstices by means of pumping or pressurizing the fluid, and while being heated by the heated TSM that the fluid flows past, and removing the fluid from the container via a second one of the plurality of fluid communication port that is located at a second height above the first height; and
subsequently discontinuing the removal of the fluid from the container via the second one of the fluid communication ports and instead removing the fluid from the container via a third one of the plurality of fluid communication ports at a third height that is higher than the second height, and wherein the fluid removed from the container via the third fluid communication port has flowed through the interstices by means of pumping or pressurizing the fluid while being heated by the heated TSM that the fluid flows past.

13. The method of claim 12, further comprising:
monitoring one or more temperatures inside the container,
wherein discontinuing the removal of the heated fluid from the container via the second one of the plurality of fluid communication ports and instead removing the heated fluid from the container via the third one of the plurality of fluid communication ports occurs automatically in response to a signal indicating that a particular one of the monitored temperatures has reached a predetermined value.

14. The method of claim 12, further comprising utilizing the heated fluid for a practical application.

15. The method of claim 12, wherein the TSM comprises magnesium.

16. A method comprising:
providing a thermal energy source at a first location;
providing a plurality of movable vessels, each of which comprises one or more containers for thermal storage material (TSM);
establishing a first load of heated TSM in a first container on a first one of the plurality of movable vessels using thermal energy from the thermal energy source;
physically transporting the first load of heated TSM from the first location to a second location with the first one of the plurality of movable vessels, wherein the second location is different than the first location;
removing the thermal energy from the first load of heated TSM at the second location for a practical purpose;
establishing a second load of heated TSM in a second container on a second one of the plurality of movable vessels using thermal energy from the thermal energy source, while the first load of heated TSM is being physically transported or utilized at the second location;
physically transporting the second load of heated TSM from the first location to the second location or to a third location with the second one of the plurality of movable vessels, wherein the third location is different than the first location and the second location; and
removing the thermal energy from the second load of heated TSM at the second or third location for a practical purpose,
wherein establishing the first load of heated TSM in the first container on the first one of the plurality of movable vessels using thermal energy from the thermal energy source comprises;
initially providing the first container in an empty condition on the first one of the plurality of movable vessels;
initially providing a first load of unheated liquid TSM in a second container also on the first one of the plurality of movable vessels; and
pumping the unheated liquid TSM from the second container through a heat exchanger to absorb heat from the thermal energy source and into the first container.

17. (canceled)

18. The method of claim 16, further comprising:
establishing a first fluid communication path:
from the first container on the first one of the plurality of movable vessels to the heat exchanger; and
from the heat exchanger to the second container on the first one of the plurality of movable vessels,
wherein the first fluid communication path facilitates flow of the unheated liquid TSM from the second container, through the heat exchanger, and into the first container.

19. The method of claim 18, further comprising:
establishing, but temporarily preventing fluid flow through, a second fluid communication path:
from a first container on the second one of the plurality of movable vessels to the heat exchanger; and
from the heat exchanger to the second container on the second one of the plurality of movable vessels,
wherein the second fluid communication path is configured, when the temporary fluid flow prevention is removed, to facilitate flow of the unheated liquid TSM from the first container on the second one of the plurality of movable vessels, through the heat exchanger, and into the second container on the second one of the plurality of movable vessels.

20. The method of claim 19, wherein the second fluid communication path is established, but with the temporary fluid flow prevention, while the first fluid communication path is in place.

21. The method of claim 16, wherein establishing the first load of heated TSM in the first container on the first one of the plurality of movable vessels using thermal energy from the thermal energy source comprises:
providing a first load of unheated solid TSM in the first container of the first one of the plurality of movable vessels;
transferring the thermal energy from the thermal energy source into an intermediary fluid to produce a heated intermediary fluid;
pumping the heated intermediary fluid to the unheated solid TSM; and
transferring thermal energy from the heated intermediary fluid into the unheated solid TSM by allowing the heated intermediary fluid to flow over the unheated solid TSM to produce the first load of heated TSM.

22. The method of claim 16, further comprising:
providing three connection points for fluid flow connections for a heat exchanger for the thermal energy source.

23. The method of claim 22, wherein establishing the second load of heated TSM in the second container on the second one of the plurality of movable vessels using thermal energy from the thermal energy source comprises:
establishing a first fluid communication path between the first container on the first one of the plurality of movable vessels and the heat exchanger via a first one of the three connection points;
establishing a second fluid communication path between the heat exchanger and the second container on the second one of the plurality of movable vessels via a second one of the three connection points;
establishing, but temporarily preventing flow through, a third fluid flow path between the heat exchanger and a third container on a third one of the plurality of movable vessels via a third one of the three connection points.

24. The method of claim 23, wherein establishing the second load of heated TSM in the second container on the second one of the plurality of movable vessels using thermal energy from the thermal energy source further comprises:
pumping a liquid TSM:
from the first container on the first one of the plurality of movable vessels to the heat exchanger via the first fluid communication path,
through the heat exchanger to heat the liquid TSM and thereby produce the second load of heated TSM; and
from the heat exchanger to the second container on the second one of the plurality of movable vessels via the second fluid communication path.

25. The method of claim 24, further comprising:
stopping fluid flow through the first fluid communication path; and
detaching a fluid line that extends from the second container on the second one of the plurality of movable vessels from the second one of the three connection points so that the second one of the plurality of vessels is free to physically transport the second load of heated TSM from the first location to the second location or to the third location.

26. The method of claim 25, further comprising:
terminating the temporary prevention of fluid flow through the third fluid flow path between the heat exchanger and the third container on the third one of the plurality of movable vessels; and
pumping the liquid TSM:
from the third container on the third one of the plurality of movable vessels to the heat exchanger via the third fluid communication path,
through the heat exchanger to heat the liquid TSM and thereby produce the first load of heated TSM; and
from the heat exchanger to the first container on the first one of the plurality of movable vessels via the first fluid communication path.

27. The method of claim 26, further comprising:
establishing a fourth fluid flow path between the heat exchanger and a fourth container on a fourth one of the plurality of movable vessels via the second one of the three connection points.

28. The method of claim 16, wherein the TSM comprises magnesium.

29-34. (canceled)

35. A method comprising:
providing an electrical generator to produce electricity at a first location;
providing two or more connection points for accessing the electricity produced by the electrical generator;
providing a plurality of movable vessels, each of which comprises a container containing thermal storage material (TSM);
transferring the electricity to a first one of the plurality of movable vessels via a first one of the two or more connection points;
transforming the electricity into thermal energy onboard the first one of the plurality of movable vessels and storing the thermal energy in the TSM on the first one of the plurality of movable vessels to create a first load of heated TSM;
physically transporting the first load of heated TSM from the first location to a second location with the first one of the plurality of movable vessels, wherein the second location is different than the first location;
removing the thermal energy from the first load of heated TSM at the second location for a practical purpose;
transferring the electricity to a second one of the plurality of movable vessels via a second one of the two or more connection points:
transforming the electricity into thermal energy onboard the second one of the plurality of movable vessels and storing the thermal energy in the TSM on the second one of the plurality of movable vessels to create a second load of heated TSM;
physically transporting the first load of heated TSM from the first location to a second location with the first one of the plurality of movable vessels, wherein the second location is different than the first location: and
removing the thermal energy from the first load of heated TSM at the second location for a practical purpose.

36. (canceled)

37. The method of claim 35, wherein transferring the electricity to the second one of the plurality of movable vessels overlaps transferring the electricity to the first one of the plurality of movable vessels.

38. The method of claim 35, wherein transferring the electricity to the second one of the plurality of movable vessels does not overlap transferring the electricity to the first one of the plurality of movable vessels.

39. The method of claim 35, wherein the electricity is transformed into thermal energy by use of a heater or heat pump that uses the electricity to heat an intermediary fluid that is then delivered to the TSM.

40. The method of claim 35, wherein the electricity is transformed into thermal energy by passing the electricity through one or more electrical resistance heaters that are physically or thermally coupled to the TSM.

41. The method of claim 35, wherein the TSM comprises magnesium.

42. A method comprising:
providing a thermal energy source at a first location;
providing a heat exchanger to transfer heat from the thermal energy source to a TSM liquid;
providing at least four fluid flow connection points for the heat exchanger;
providing a first storage container co-located with the heat exchanger, wherein the first storage container contains a liquid TSM;
establishing a first fluid communication path between the first storage container and a first one of the fluid flow connection points for the heat exchanger;
providing a movable vessel that comprises a vessel storage container;
establishing a second fluid communication path between the vessel storage container and a second one of the fluid flow connection points for the heat exchanger;
pumping the liquid TSM from the first storage container to the heat exchanger via the first fluid communication path and from the heat exchanger to the vessel storage container on the movable vessel via the second fluid communication path; and
heating the liquid TSM with the heat exchanger to produce a heated TSM;
physically transporting the heated TSM inside the vessel storage container to a second location with the movable vessel, wherein the second location is different than the first location; and
removing heat from the heated TSM at the second location for a practical purpose.

43. A method comprising:
providing a thermal energy source at a first location;
providing a heat exchanger to transfer heat from the thermal energy source to a TSM liquid;
providing at least five fluid flow connection points for the heat exchanger,
providing a first storage container co-located with the heat exchanger, wherein the first storage container contains an unheated liquid TSM;
establishing a first fluid communication path between the first storage container and a first one of the fluid flow connection points for the heat exchanger;
providing a second storage container co-located with the heat exchanger, wherein the second storage container is empty;
establishing a second fluid communication path between the second storage container and a second one of the fluid flow connection points for the heat exchanger;
pumping the liquid TSM from the first storage container to the heat exchanger via the first fluid communication path and from the heat exchanger to the second storage container via the second fluid communication path; and
heating the liquid TSM with the heat exchanger to produce a heated TSM;
storing the heated TSM in the second storage container.

44. The method of claim 43, further comprising:
providing a movable vessel that comprises a vessel storage container;
establishing a third fluid communication path between the vessel storage container and the second storage container via the third one and the second one of the fluid flow connection points and a manifold or piping system that enables the third fluid communication path to bypass the heat exchanger;
pumping the heated TSM from the second storage container to the vessel storage container via the third fluid communication path; and
physically transporting the heated TSM inside the vessel storage container to a second location with the movable vessel, wherein the second location is different than the first location; and
removing beat from the heated TSM at the second location for a practical purpose.

45. A method comprising:
providing a thermal energy source at a first location;
providing a heat exchanger to transfer heat from the thermal energy source to a TSM liquid;
providing at least four fluid flow connection points for the heat exchanger;
providing a first movable vessel comprising a first storage container and a second storage container, wherein the first storage container contains an unheated liquid TSM, and wherein the second storage container is empty;
establishing a first fluid communication path between the first storage container on the first movable vessel and a first one of the fluid flow connection points for the heat exchanger;
establishing a second fluid communication path between the second storage container on the first movable vessel and a second one of the fluid flow connection points for the heat exchanger;
pumping the unheated liquid TSM from the first storage container on the first movable vessel to the heat exchanger via the first fluid communication path and from the heat exchanger to the second storage container on the first movable vessel via the second fluid communication path;
providing a second movable vessel comprising a third storage container and a fourth storage container, wherein the third storage container contains an unheated liquid TSM, and wherein the fourth storage container is empty;
establishing a third fluid communication path between the third storage container on the second movable vessel and a third one of the fluid flow connection points for the heat exchanger;
establishing a fourth fluid communication path between the fourth storage container on the second movable vessel and a fourth one of the fluid flow connection points for the heat exchanger,
wherein the third and fourth fluid flow connection points for the heat exchanger are in place while the unheated liquid TSM from the first storage container on the first movable vessel is being pumped to the heat exchanger via the first fluid communication path and from the heat exchanger to the second storage container on the first movable vessel via the second fluid communication path.

46. The method of claim 45, further comprising:
a sensor and control mechanism that starts to pump the unheated liquid TSM from the third storage container on the second movable vessel to the heat exchanger via the third fluid communication path and from the heat exchanger to the fourth storage container on the second movable vessel via the fourth fluid communication path, as soon as all the unheated liquid TSM from the first storage container on the first movable vessel has been heated by the heat exchanger and transferred to the second storage container on the first movable vessel.
